(19) United States
(12) Patent Application Publication
(10) Pub. No.: US 2017/0242367 A1
(43) Pub. Date: Aug. 24, 2017

(54) DEVELOPER SUPPLY CONTAINER AND DEVELOPER SUPPLYING APPARATUS

(71) Applicant: CANON KABUSHIKI KAISHA, Tokyo (JP)

(72) Inventors: Manabu Jimba, Tsukuba-shi (JP); Ayatomo Okino, Moriya-shi (JP); Nobuyuki Yomoda, Kashiwa-shi (JP); Yusuke Oizumi, Kasumigaura-shi (JP); Akihito Kamura, Kashiwa-shi (JP)

(21) Appl. No.: 15/589,670

(22) Filed: May 8, 2017

Related U.S. Application Data
(63) Continuation of application No. PCT/JP2015/082057, filed on Nov. 10, 2015.

(30) Foreign Application Priority Data
Nov. 10, 2014 (JP) 2014-228136

(51) Int. Cl. G03G 15/08

(52) U.S. Cl. CPC G03G 15/0877; G03G 15/0875; G03G 15/0822; G03G 15/06

(57) ABSTRACT

A developer supply container 1 includes a cylindrical portion 2k capable of accommodating a developer; a second discharge opening 4a, provided on the cylindrical portion 2k, for permitting discharge of the developer; a storage portion 4d provided in the cylindrical portion 2k and capable of storing a predetermined amount of the developer through the second discharge opening 4a; a pump portion 3a having a changeable inside volume of cylindrical portion 2k in a longitudinal direction of the supply container 1 to apply a pressure at least to the second discharge opening 4a; a fluid communication path 20a providing fluid communication between the pump portion 3a and the storage portion 4d; and a partition 20 provided in a connecting portion between the pump portion 3a and the fluid communication path 20a for suppressing flow of the air which is produced by pump portion 3a and which is directed to toward cylindrical portion 2k at least in a discharging operation.

### FIELD OF THE INVENTION

The present invention relates to a developer supply container detachably mountable to a developer supplying apparatus and also relates to the developer supplying apparatus. The developer supplying apparatus is used with an image forming apparatus such as a copying machine, a facsimile machine, a printer or a complex machine having functions of a plurality of such machines.

### BACKGROUND ART

The apparatus disclosed in Japanese Laid-open Patent Application 2010-256894 employs a system in which the developer is discharged using a bellow pump provided in the supply container. More particularly, the bellow pump is expanded to provide a pressure lower than the ambient pressure in the supply container, so that the air is taken into the supply container to fluidize the developer. In addition, the bellow pump is contracted to provide a pressure higher than the ambient pressure in the supply container, so that the developer is pushed out by the pressure difference between the inside and the outside of the supply container, thus discharging the developer. By repeating the two steps alternately, the developer is stably discharged.

In the apparatus disclosed in 2014-186138, a storage portion accommodating a constant amount of the developer is provided adjacent to the discharge opening, by which the amount of the flow of the developer into the storage portion is controlled. With this structure, more stabilized discharging property is accomplished than that of the supply container disclosed in the Japanese Laid-open Patent Application 2010-256894.

However, in the apparatus disclosed in Japanese Laid-open Patent Application 2010-256894 or 2014-186138, the use is made with a bellow pump to produce a pressure difference between the total inside volume of the supply container and outside of the supply container. Therefore, a large pressure difference is required between the inside of the developer accommodating chamber of the supply container and the outside in order to assure that the developer is sufficiently loosened and to stably discharged from the beginning, even in the case that the developer of the storage portion provided adjacent to the discharge opening inside the supply container is packed during the transportation or the like of the supply container. As a result, an expansion and contraction amount of the bellow pump is required to be large, or the inside volume of the bellow pump is required to be large. Then, the size of the supply container is large, thus requiring a large space for the supply container in the main assembly of the image forming apparatus. Under the circumstances, the structure for enhancing concentration of the air to the discharge opening during the toner discharging is desired.

### Problem to be Solved by the Invention

It is another object of the present invention to provide a developer supply container in which the concentration of the air to the discharging portion during the toner discharging can be enhanced, so that the developer can be stably discharged.

### Means for Solving the Problem

According to an aspect of the present invention, there is provided a developer supply container detachably mountable to a developer supplying apparatus, said developer supply container comprising a developer accommodating chamber capable of accommodating a developer; a discharge opening, provided on said developer accommodating chamber, for permitting discharge of the developer therein; a storage portion provided in said developer accommodating chamber and capable of storing a predetermined amount of the developer through said discharge opening; a pump portion having a changeable inside volume with reciprocation and actable at least on said storage portion; an air hole portion providing fluid communication between said pump portion and said storage portion; and a suppressing portion capable of suppressing air directing toward said developer accommodating chamber from said pump portion while permitting supply of air from said pump portion to said air hole portion, at least in a discharging operation.

### Effect of the Invention

According to the present invention, the air can be concentrated to the discharging portion during the toner discharging, and therefore, the developer can be stably discharged.

### BRIEF DESCRIPTION OF THE DRAWINGS

FIG. 1 is a sectional view of an image forming apparatus according to Embodiment 1.

Part (a) of FIG. 2 is a partially sectional view of the developer supplying apparatus, (b) is a perspective view of a mounting portion for mounting the supply container, and (c) is a sectional view of the mounting portion.

FIG. 3 shows a control system and a partially enlarged view of the supply container and the supplying device.

FIG. 4 is a flow chart illustrating a flow of developer supply operation controlled by the control system.

FIG. 5 is a sectional view illustrating a structure in which the developer is supplied directly (without use of a hopper) into a developing device from the supply container.

FIG. 6 (a) is a perspective view of an entirety of the supply container, FIG. 6 (b) is a partially enlarged view of the elements around a discharge opening of the supply container, FIG. 6 (c) is a front view illustrating a state in which the supply container is mounted to the mounting portion.

Part (a) of FIG. 7 is a sectional perspective view of the supply container, (b) is a partially sectional view in a state in which the pump portion is expanded to the maximum usable limit, and (c) is a partially sectional view in a state in which the pump portion is contracted to the maximum usable limit.

Parts (a) and (b) of FIG. 8 are schematic views of a device for measuring fluidity energy.

FIG. 9 is a graph showing a relation between a diameter of a discharge opening and a discharge amount, for various developers.

FIG. 10 shows a relationship between a developer discharge amount and an amount of the developer in the container, for the developer T.

Part (a) of FIG. 11 is a partial view in a state in which the pump portion is expanded to the maximum usable limit, (b) is a partial view in a state in which the pump portion is contracted to the maximum usable limit, and (c) is a partial view of the pump portion.

FIG. 12 is a development of the cam groove in the driving force converting mechanism (cam mechanism comprising the engaging projection and the cam)

FIG. 13 is graphs showing changes of the pressure in the expanding-and-contracting operation of the pump portion in the state that the shutter of the supply container is opened so that the second discharge opening is opened to the outside air.

Part (a) of FIG. 14 is a perspective view of the feeding member provided in the supply container, part (b) of FIG. 14 is a side view of the feeding member, and part (c) of FIG. 14 is a front view of the feeding member.

FIG. 15 shows the state of the supply container in the operation rest step in which the pump portion does not operate.

FIG. 16 shows a suction stroke which is partway from the most contracted state of the pump to the most expanded state thereof.

FIG. 17 shows a discharging stroke which is partway from the most expanded state of the pump to the most contracted state thereof.

Part (a) of FIG. 18 is a perspective view of the flange portion of the supply container according to Embodiment 2, as seen from the accommodation chamber side, and part (b) is a sectional view of the flange portion.

FIG. 19 is a sectional view of the developer supply container.

FIG. 20 is a partly enlarged perspective view of the supply container according to a comparison example (conventional example).

FIG. 21 is an enlarged perspective view of the feeding member of the supply container according to a modified example of Embodiment 2.

Part (a) of FIG. 22 is a perspective view of the flange in the supply container according to Embodiment 3, and part (b) of FIG. 22 is a sectional view illustrating a positional relation of the feeding member and the flange portion in the discharging stroke in this embodiment.

### DESCRIPTION OF THE EMBODIMENTS

Embodiments of the present invention will be described in detail in conjunction with the accompanying drawings. The preferred embodiments of the present invention will be described in conjunction with the accompanying drawings. Here, the dimensions, the sizes, the materials, the configurations, the relative positional relationships of the elements in the following embodiments and examples are not restrictive to the present invention unless otherwise stated. In the description of the embodiments, the same reference numerals as in the previous embodiment are assigned to the elements having the corresponding functions in this embodiment, and the detailed description thereof is omitted for simplicity.

### Embodiment 1

First, basic structures of an image forming apparatus will be described, and then, a developer supplying system, that is, a developer replenishing apparatus and a supply container used in the image forming apparatus will be described.

### (Image Forming Apparatus)

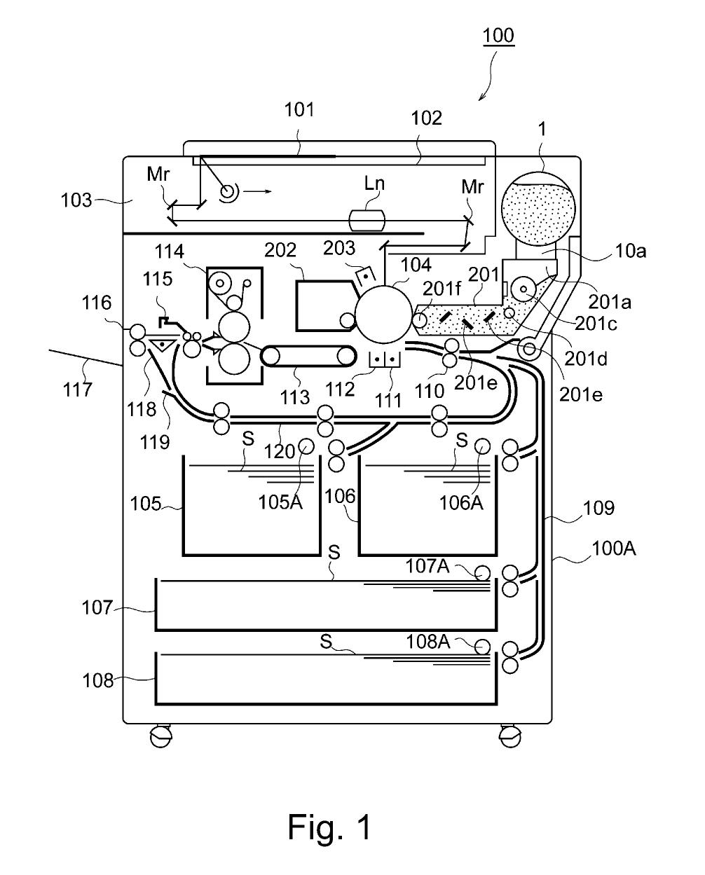

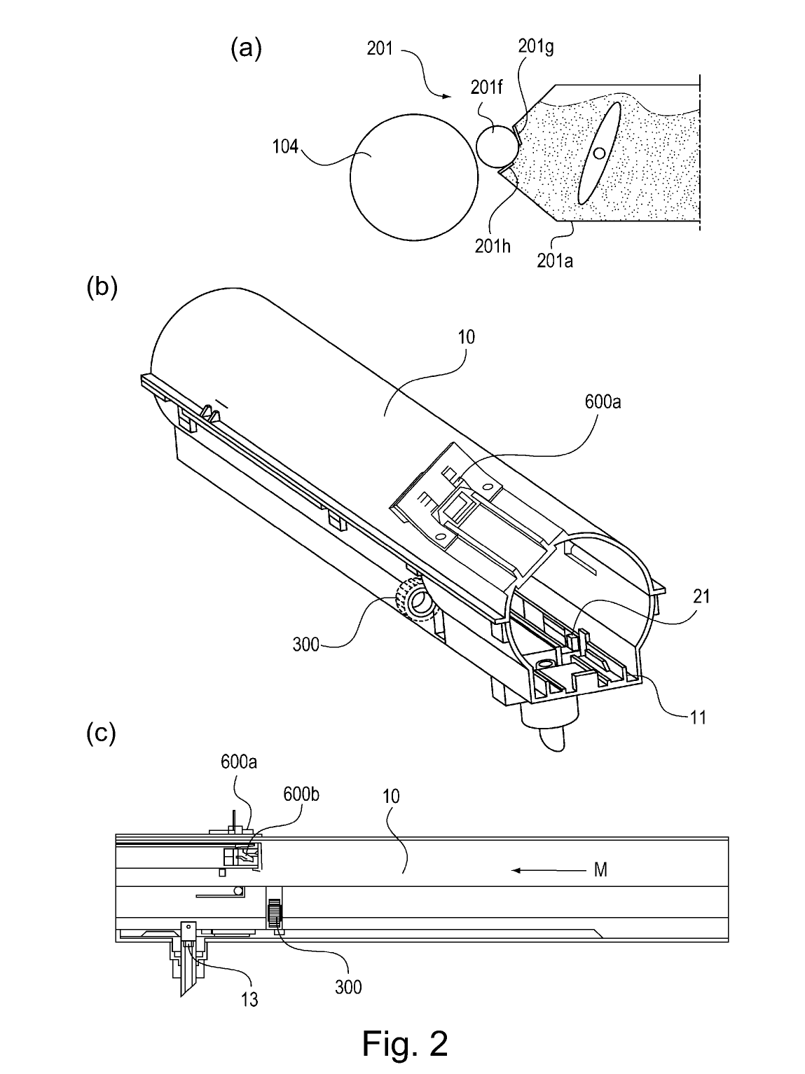

FIG. 1 is a sectional view of an image forming apparatus 100 according to Embodiment 1 The image forming apparatus 100 is an example of an electrophotographic type copying machine (electrophotographic image forming apparatus) and is provided with a supplying device 201 to which a supply container 1 (so-called toner cartridge) is detachably mountable (demountable). The supply container 1 as the “developer supply container” is detachably mountable to the supplying device 201 as “developer supplying apparatus”, that is, detachably mountable to a main assembly 100A of the image forming apparatus. Therefore, when the supply container 1 and/or the supplying device 201 is in the form of a cartridge, the cartridge is detachably mounted to the main assembly 100A.

The image forming apparatus 100 comprises the main assembly 100A. An original 101 is placed on an original supporting platen glass 102. A light image corresponding to image information of the original is imaged on an electrophotographic photosensitive drum 104 as an image bearing member by way of a plurality of mirrors M of an optical portion 103 and a lens Ln, so that an electrostatic image is formed. The electrostatic image is visualized with toner (one component magnetic toner) as a developer (dry powder) by a dry type developing device (one component developing device) 201a.

In this embodiment, the one component magnetic toner is used as the developer to be supplied from a supply container 1, but the present invention is not limited to the example and includes other examples which will be described hereinafter. Specifically, in the case that a one component developing device using the one component non-magnetic toner is employed, the one component non-magnetic toner is supplied as the developer. In addition, in the case that a two component developing device using a two component developer containing mixed magnetic carrier and non-magnetic toner is employed, the non-magnetic toner is supplied as the developer. In such a case, both of the non-magnetic toner and the magnetic carrier may be supplied as the developer.

Cassettes 105-108 accommodates recording materials (sheets) S. Of the sheet S stacked in the cassettes 105-108, an optimum cassette is selected on the basis of a sheet size of the original 101 or information inputted by the operator (user) from a liquid crystal operating portion of the copying machine. The recording material is not limited to a sheet of paper, but OHP sheet or another material can be used as desired. One sheet S supplied by a separation and feeding device 105A-108A is fed to registration rollers 110 along a feeding portion 109, and is fed at timing synchronized with rotation of a photosensitive drum 104 and with scanning of an optical portion 103.

Below the photosensitive drum 104, there are provided a transfer charger 111 and a separation charger 112. An image of the developer formed on the photosensitive drum 104 is transferred onto the sheet S by a transfer charger 111. Then, the sheet S carrying the developed image (toner image) transferred thereonto is separated from the photosensitive drum 104 by the separation charger 112. Thereafter, the sheet S fed by the feeding portion 113 is subjected to heat and pressure in a fixing portion 114 so that the developed image on the sheet is fixed, and then passes through a discharging/reversing portion 115, in the case of one-sided copy mode, and subsequently the sheet S is discharged to a discharging tray 117 by discharging rollers 116.

In the case of a duplex copy mode, the sheet S enters the discharging/reversing portion 115 and a part thereof is ejected once to an outside of the main assembly 100A by the discharging roller 116. The trailing end thereof passes through a flapper 118, and a flapper 118 is controlled when it is still nipped by the discharging rollers 116, and the discharging rollers 116 are rotated reversely, so that the sheet S is refed into the main assembly 100A. Then, the sheet S is fed to the registration rollers 110 by way of re-feeding portions 119, 120, and then conveyed along the path similarly to the case of the one-sided copy mode and is discharged to the discharging tray 117.

In the main assembly 100A, around the photosensitive drum 104, there are provided image forming process equipment (process means) such as a developing device 201a as the developing means a cleaner portion 202 as a cleaning means, a primary charger 203 as charging means. The developing device 201a develops the electrostatic latent image formed on the photosensitive drum 104 by the optical portion 103 in accordance with image information of the 101, by depositing the developer (toner) onto the latent image. The primary charger 203 functions to uniformly charge the surface of the photosensitive drum 104 so that an intended electrostatic image is formed on the photosensitive drum 104. In addition, the cleanup portion 202 is to remove the developer remaining on the photosensitive drum 104.

### (Supplying Device)

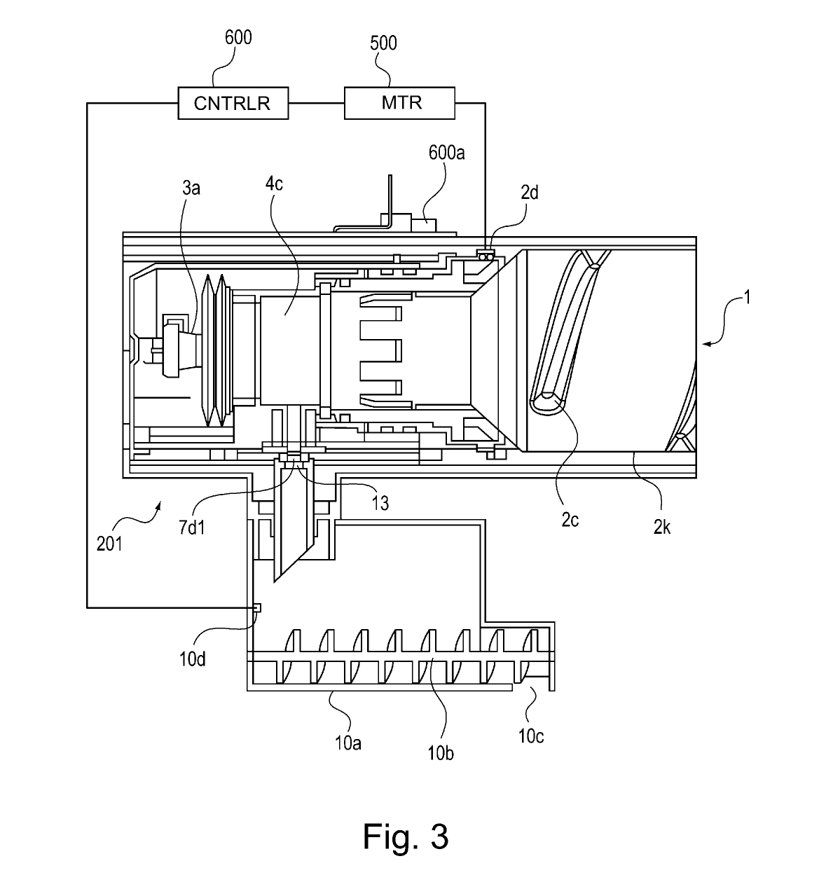

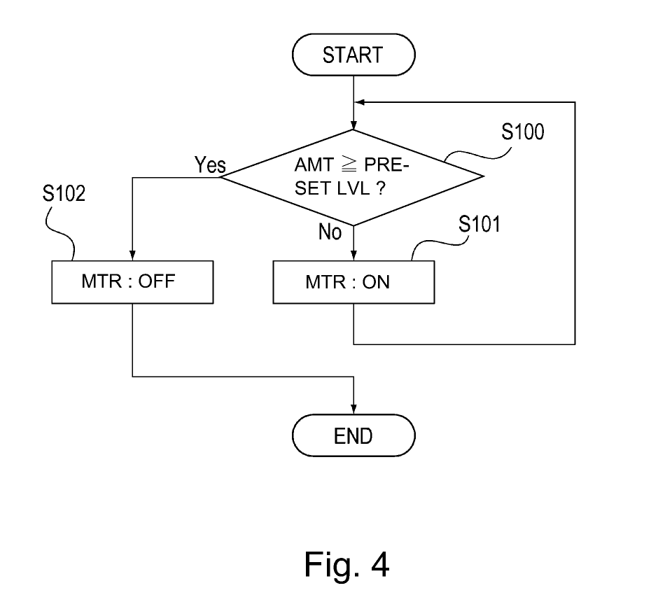

Part (a) of FIG. 2 is a partially sectional view of the developer supplying apparatus, (b) is a perspective view of a mounting portion, and (c) is a sectional view of the mounting portion. FIG. 3 is partly enlarged sectional views of a control system, the supply container 1 and the developer replenishing apparatus 201. FIG. 4 is a flow chart illustrating a flow of developer supply operation controlled by the control system. Referring to FIGS. 1-4, the supplying device 201 which is a constituent-element of the developer supplying system will be described. The supply container 1 as the “developer supply container” is detachably mountable to the supplying device 201 as the “developer supplying apparatus”.

As shown in FIG. 1, the developer replenishing apparatus 201 comprises the mounting portion (mounting space) 10 (part (b) of FIG. 2), to which the supply container 1 is mounted dismountably, a hopper 10a for storing temporarily the developer discharged from the supply container 1, and the developing device 201a. As shown in part (c) of FIG. 2, the supply container 1 is mountable in a direction indicated by an arrow M to the mounting portion 10. Thus, a longitudinal direction (rotational axis direction) of the supply container 1 is substantially the same as the direction of arrow M. The direction of arrow M is substantially parallel with a direction indicated by X of part (b) of FIG. 7 which will be described hereinafter. In addition, a dismounting direction of the supply container 1 from the mounting portion 10 is opposite the direction (inserting direction) of the arrow M.

As shown in FIG. 1 and part (a) of FIG. 2, the developing device 201a comprises a developing roller 201f as the “developer carrying member” for carrying the developer, a stirring member 201c, and feeding members 201d and 201e. The developer supplied from the supply container 1 is stirred by the stirring member 201c, is fed to the developing roller 201f by the magnet roller 201d and the feeding member 201e, and is supplied to the photosensitive drum 104 by the developing roller 201f.

A developing blade 201 g for regulating an amount of developer coating on the roller is provided relative to the developing roller 201f, and a leakage preventing sheet 201h is provided contacted to the developing roller 201f to prevent leakage of the developer between the developing device 201a and the developing roller 201f.

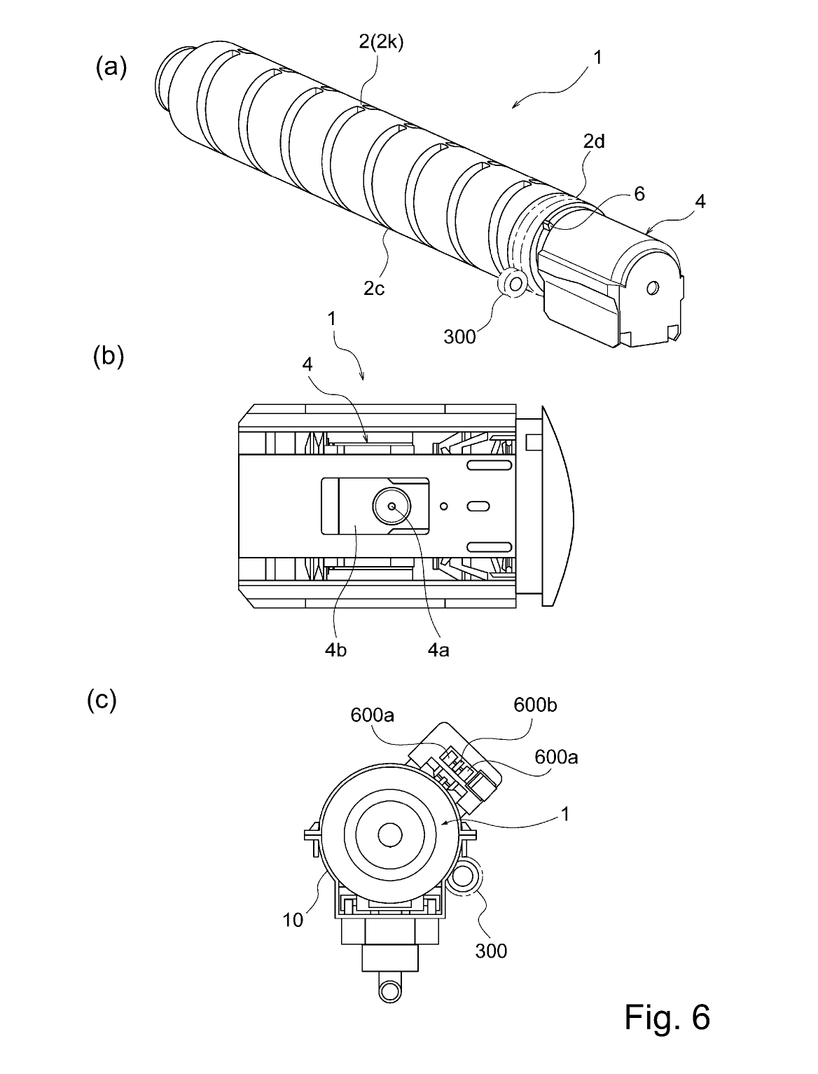

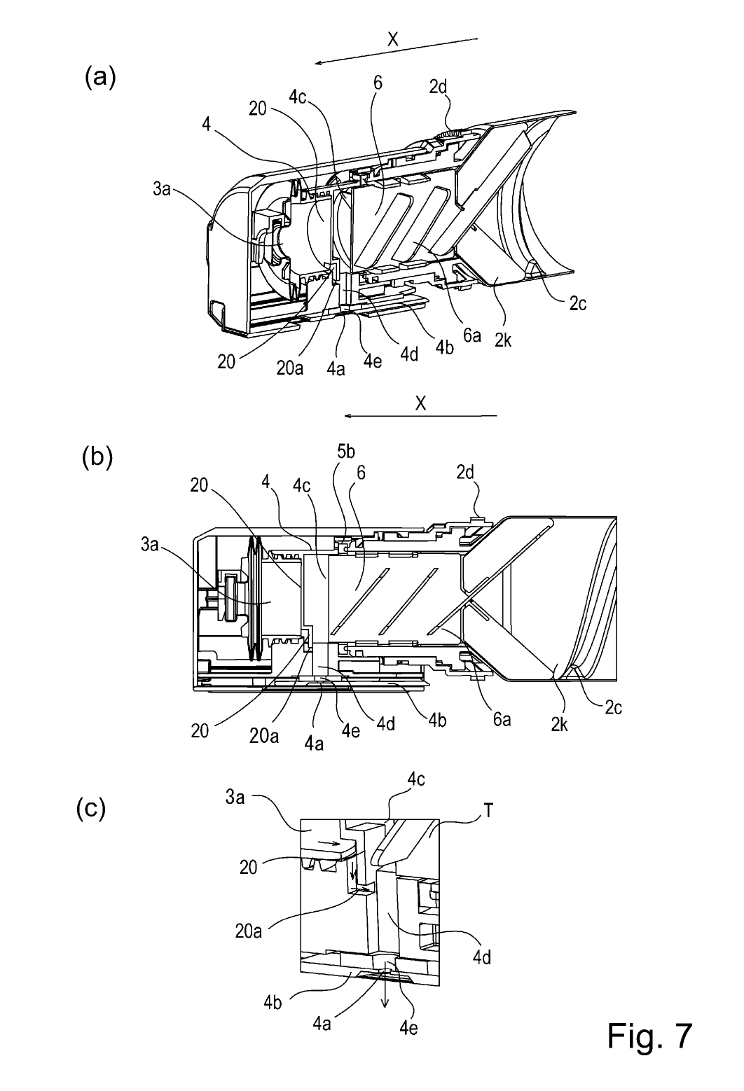

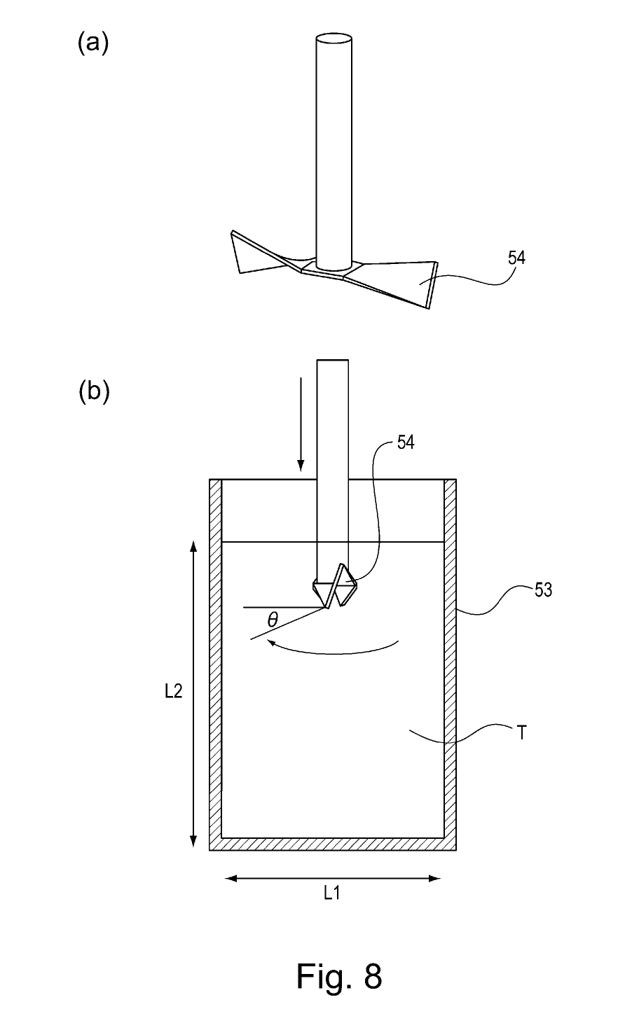

As shown in part (b) of FIG. 2, the mounting portion 10 is provided with a rotation direction regulating portion (holding mechanism) 11 for limiting movement of the flange portion 4 in the rotational moving direction by abutting to a flange portion 4 (FIG. 6) of the supply container 1 when the supply container 1 is mounted.

Furthermore, the mounting portion 10 is provided with a developer receiving port (developer reception hole) 13 (FIG. 3) for receiving the developer discharged from the supply container 1, and the developer receiving port is brought into fluid communication with a second discharge opening (discharging port) 4a (FIG. 6) of the supply container 1 which will be described hereinafter, when the supply container 1 is mounted thereto. The developer is supplied from the second discharge opening 4a of the supply container 1 to the hopper 10a through the developer receiving port 13. In this embodiment, a diameter φ of the developer receiving port 13 is approx. 2 mm (pin hole), for the purpose of preventing as much as possible the contamination by the developer in the mounting portion 10. The diameter of the developer receiving ports 13 may be any if the developer can be discharged through the second discharge opening 4a.

As shown in FIG. 3, the hopper 10a comprises a feeding screw 10b for feeding the developer to the developing device 201a an opening 10c in fluid communication with the developing device 201a and a developer sensor (developer remainder amount sensor) 10d for detecting an amount of the developer accommodated in the hopper 10a.

As shown in parts (b) and (c) of FIG. 2, the mounting portion 10 is provided with a driving gear 300 functioning as a driving mechanism (driver). The driving gear 300 receives a rotational force from a driving motor 500 (FIG. 3) through a driving gear train, and functions to apply a rotational force to the supply container 1 which is set in the mounting portion 10.

As shown in FIG. 3, the driving motor 500 is controlled by a control device (CPU) 600. As shown in FIG. 3, the control device 600 controls the operation of the driving motor 500 on the basis of information indicative of a developer remainder inputted from the developer sensor 10d.

In this example, the driving gear 300 is rotatable unidirectionally to simplify the control for the driving motor 500. The control device 600 controls only ON (operation) and OFF (non-operation) of the driving motor 500. This simplifies the driving mechanism for the developer replenishing apparatus 201 as compared with a structure in which forward and backward driving forces are provided by periodically rotating the driving motor 500 (driving gear 300) in the forward direction and backward direction.

### (Mounting/Dismounting Method of Supply Container)

The description will be made as to mounting/dismounting method of the supply container 1. First, the operator opens an exchange cover and inserts and mounts the supply container 1 to a mounting portion 10 of the developer replenishing apparatus 201. With the mounting operation, the flange portion 4 of the supply container 1 is held and fixed in the developer replenishing apparatus 201. Thereafter, the operator closes the exchange cover to complete the mounting step. Thereafter, the control device 600 controls the driving motor 500, by which the driving gear 300 rotates at proper timing.

On the other hand, when the supply container 1 becomes empty, the operator opens the exchange cover and takes the supply container 1 out of the mounting portion 10. The operator inserts and mounts a new supply container 1 prepared beforehand and closes the exchange cover, by which the exchanging operation from the removal to the remounting of the supply container 1 is completed.

### (Developer Supply Control by Developer Replenishing Apparatus)

Referring to a flow chart of FIG. 4, a developer supply control by the developer replenishing apparatus 201 will be described. The developer supply control is executed by controlling various equipment by the control device (CPU) 600. In this example, the control device 600 controls the operation/non-operation of the driving motor 500 in accordance with an output of the developer sensor 10d by which the developer is not accommodated in the hopper 10a beyond a predetermined amount.

The developer sensor 10d checks the accommodated developer amount in the hopper 10a (S100). When the accommodated developer amount detected by the developer sensor 10d is discriminated as being less than a predetermined amount, that is, when no developer is detected by the developer sensor 10d, the driving motor 500 is actuated to execute a developer supplying operation for a predetermined time period (S101).

When the accommodated developer amount detected with developer sensor 10d is discriminated as having reached the predetermined amount, that is, when the developer is detected by the developer sensor 10d, as a result of the developer supplying operation, the control device 600 deactuates the motor 500 to stop the developer supplying operation (S102). By the stop of the supplying operation, a series of developer supplying steps is completed. Such developer supplying steps are carried out repeatedly whenever the accommodated developer amount in the hopper 10a becomes less than a predetermined amount as a result of consumption of the developer by the image forming operations.

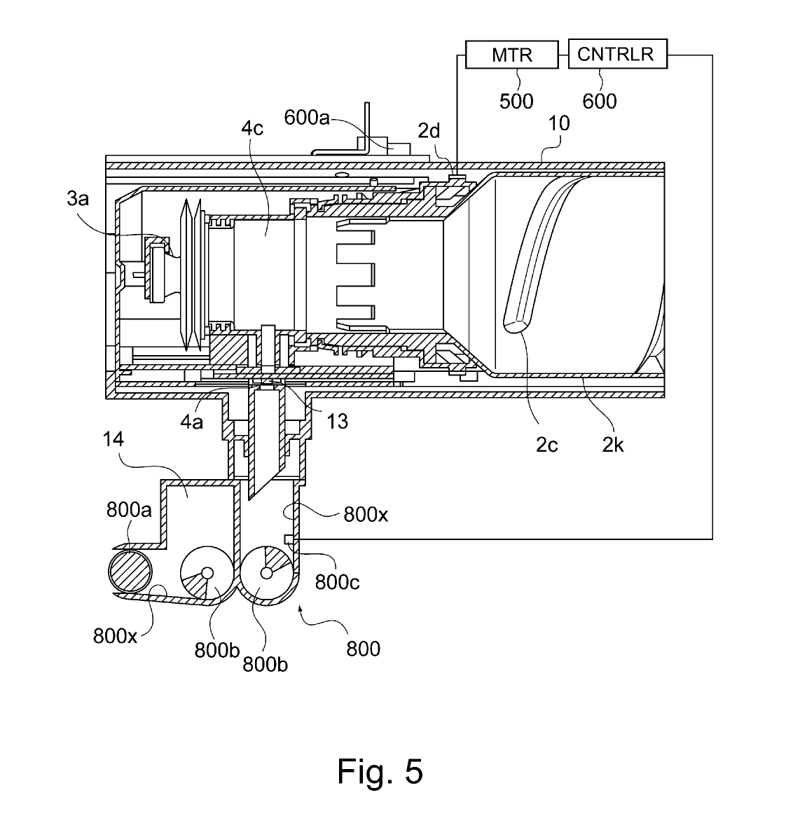

FIG. 5 is a sectional view illustrating a structure in which the hopper 10a of FIG. 3 is omitted, and the developer is directly supplied to the developing device 800 from the supply container 1. In FIG. 3, the developer discharged from the supply container 1 is stored temporarily in the hopper 10a, and then is supplied into the developing device 201a, the supplying device 201 may have the structure of FIG. 5. FIG. 5 shows an example of a developing device 800 using two component developer supplied from the supplying device 201. The developing device 800 comprises a stirring chamber 800x into which the developer is stirred, and a developer chamber 800y for supplying the developer to the developing sleeve 800a, wherein the stirring chamber 800x and the developer chamber 800y are provided with stirring screws 800b rotatable in such directions that the developer is fed in the opposite directions from each other.

The stirring chamber 800x and the developer chamber 800y are communicated with each other in the opposite longitudinal end portions, and the two component developer are circulated the two chambers. The stirring chamber 800x is provided with a magnetometric sensor 800c for detecting a toner content of the developer, and on the basis of the detection result of the magnetometric sensor 800c, the control device 600 controls the operation of the driving motor 500. In such a case, the developer supplied from the supply container is non-magnetic toner or non-magnetic toner plus magnetic carrier.

In this example, as will be described hereinafter, the developer in the supply container 1 is hardly discharged through the second discharge opening 4a only by the gravitation, but the developer is discharged by a volume changing operation of a pump portion 3b, and therefore, variation in the discharge amount can be suppressed. Therefore, the supply container 1 which will be described hereinafter is usable for the example of FIG. 5 lacking the hopper 10a, and the supply of the developer into the developing chamber 800y is stable with such a structure.

### (Developer Supply Container)

Referring to FIGS. 6 and 7, the structure of the supply container 1 which is a constituent-element of the developer supplying system will be described. Part (a) of FIG. 6 is a perspective view illustrating the supply container according to Embodiment 1 of the present invention, (b) is a partial enlarged view illustrating a state around a discharge opening, and (c) is a front view illustrating a state in which the supply container is mounted to the mounting portion of the developer supplying apparatus. As shown in part (a) of FIG. 6, the supply container 1 includes a developer accommodating portion 2 (container body) having a hollow cylindrical inside space for accommodating the developer. In this example, a cylindrical portion 2k and the discharging portion 4c function as the developer accommodating portion 2.

Furthermore, the supply container 1 is provided with a flange portion 4 (non-rotatable portion) at one end of the developer accommodating portion 2 with respect to the longitudinal direction (developer feeding direction). The cylindrical portion 2 is rotatable relative to the flange portion 4. A cross-sectional configuration of the cylindrical portion 2k may be non-circular as long as the non-circular shape does not adversely affect the rotating operation in the developer supplying step. For example, it may be oval configuration, polygonal configuration or the like.

### (Material of Supply Container)

In this example, as will be described hereinafter, the developer is discharged through the discharge opening 4a by changing an internal volume of the supply container 1 by the pump portion 3a. Therefore, the material of the supply container 1 is preferably such that it provides an enough rigidity to avoid collision or extreme expansion against the volume change.

In addition, in this example, the supply container 1 is in fluid communication with an outside only through the discharge opening 4a, and is sealed except for the discharge opening 4a. Such a hermetical property as is enough to maintain a stabilized discharging performance in the discharging operation of the developer through the discharge opening 4a is provided by the decrease and increase of the volume of supply container 1 by the pump portion 3a.

Under the circumstances, this example employs polystyrene resin material as the materials of the developer accommodating portion 2 and the discharging portion 4c and employs polypropylene resin material as the material of the pump portion 3a. As for the material for the developer accommodating portion 2 and the discharging portion 4c, other resin materials such as ABS (acrylonitrile, butadiene, styrene copolymer resin material), polyester, polyethylene, polypropylene, for example are usable if they have enough durability against the volume change. Alternatively, they may be metal.

As for the material of the pump portion 3a, any material is usable if it is expansible and contractable enough to change the internal pressure of the supply container 1 by the volume change. The examples includes thin formed ABS (acrylonitrile, butadiene, styrene copolymer resin material), polystyrene, polyester, polyethylene materials. Alternatively, other expandable-and-contractable materials such as rubber are usable.

They may be integrally molded of the same material through an injection molding method, a blow molding method or the like if the thicknesses are properly adjusted for the pump portion 3a, developer accommodating portion 2 and the discharging portion 3h, respectively. In the following, the description will be made as to the structures of the flange portion 4, the cylindrical portion 2k, the pump portion 3a, the gear portion 2d, and a cam groove 2e.

### (Flange Portion)

Referring to FIG. 7, the flange portion 4 will be described. Part (a) of FIG. 7 is a perspective view of a section of the supply container 1, part (b) of FIG. 7 is a partially sectional view showing a most contracted usable state of the pump portion 3a, and part (c) of FIG. 7 is an enlarged view of the neighborhood of the storage portion 4d of the supply container 1. In these Figures, some parts are omitted for better illustration.

As shown in parts (a) and (b) of FIG. 7, there is provided a hollow discharging portion (developer discharging chamber) 4c for temporarily accommodating the developer supplied from the cylindrical portion 2k. The bottom of the discharging portion 4c is provided with the first discharge opening 4e for permitting discharge of the developer from the discharging portion 4c. Below the first discharge opening 4e, the second discharge opening 4a of the shutter 4b is disposed. The second discharge opening 4a as the discharge opening is provided in the cylindrical portion 2k to permit discharge of the developer. Above the first discharge opening 4e, the storage portion 4d is provided. The storage portion 4d is capable of storing a predetermined amount of the developer in the cylindrical portion 2k through the second discharge opening 4a.

Between the discharging portion 4c and the pump portion 3a, a partition as a suppressing portion is provided. The partition 20 isolates the space of the discharging portion 4c from the space in the pump portion 3a, so that the developer in the accommodating portion 2 is not able to freely move between the pump portion 3a and the discharging portion 4c. As shown in part (c) of FIG. 7, the partition 20 constitutes a fluid communication path 20a for fluid communication with the storage portion 4d. The partition 20 and the fluid communication path 20a will be described in detail hereinafter.

The flange portion 4 is provided with a shutter 4b for opening and closing the first discharge opening 4e. The shutter 4b is provided with the small second discharge opening 4a for supplying the developer into the supplying device 201, wherein the second discharge opening 4a is brought into fluid communication with the first discharge opening 4e with the mounting operation of the supply container 1. With the mounting operation of the supply container 1 to the mounting portion 10, the shutter 4b is brought into abutment to the abutting portion 21 (part (b) of FIG. 2) provided in the mounting portion 10.

Therefore, the shutter 4b slides relative to the supply container 1 in the rotational axis direction (opposite from the arrow M direction of part (c) of FIG. 2) of the cylindrical 2k with the mounting operation of the supply container 1 to the mounting portion 10. As a result, the second discharge opening 4a is brought into fluid communication with the first discharge opening 4e, thus completing the unsealing operation. At this time, the discharge opening 4a is positionally aligned with the developer receiving port 13 of the mounting portion 10, and therefore, they are brought into fluid communication with each other, thus enabling the developer supply from the supply container 1.

The flange portion 4 is constructed such that when the supply container 1 is mounted to the mounting portion 10 of the developer replenishing apparatus 201, it is stationary substantially. More particularly, a rotation regulating portion 11 shown in part (b) of FIG. 2 is provided so that the flange portion 4 does not rotate in the rotational direction of the cylindrical portion 2k. Therefore, in the state that the supply container 1 is mounted to the developer replenishing apparatus 201, the discharging portion 3h provided in the flange portion 3 is prevented substantially in the movement of the cylindrical portion 2k in the rotational moving direction (movement within the play is permitted). On the other hand, the cylindrical portion 2k is not limited in the rotational moving direction by the developer replenishing apparatus 201, and therefore, is rotatable in the developer supplying step.

In addition, as shown in as shown in part (a) of FIG. 7, a feeding member 6 in the form of a plate is provided to feed the developer fed from the cylindrical portion 2k by a helical projection (feeding projection) 2c to the discharging portion 4c. The feeding member 6 divides a part region of the developer accommodating portion 2 into substantially two parts, and integrally rotatable with the cylindrical portion 2k. The feeding member 6 is provided on each of the sides thereof with a plurality of inclination ribs 6a inclined toward the discharging portion 4c relative to the rotational axis direction of the cylindrical portion 2k. The inclination rib 6a as feeding portion rotates inside the cylindrical portion 2k to feed the developer.

With the above-described structure, the developer fed by the feeding projection 2c is scooped up by the plate-like feeding member 6 in interrelation with the rotation of the cylindrical portion 2k. Thereafter, with the further rotation of the cylindrical portion 2k, the developer slides down on the surface of the feeding member 6 by the gravity, and sooner or later, the developer is transferred to the discharging portion 4c by the inclination ribs 6a. With this structure of this example, the inclination ribs 6a are provided on each of the sides of the feeding member 6 so that the developer is fed into the discharging portion 4c and into the storage portion 4b for each half of the full-turn of the cylindrical portion 2k.

### (Second Discharge Opening of Flange Portion)

In this example, the size of the second discharge opening 4a of the supply container 1 is so selected that in the orientation of the supply container 1 for supplying the developer into the developer replenishing apparatus 201, the developer is not discharged to a sufficient extent, only by the gravitation. The opening size of the second discharge opening 4a is so small that the discharging of the developer from the supply container is insufficient only by the gravitation, and therefore, the opening is called pin hole hereinafter. In other words, the size of the opening is determined such that the second discharge opening 4a is substantially clogged. This is expectedly advantageous in the following points:

(1) the developer does not easily leak through the second discharge opening 4a. (2) excessive discharging of the developer at time of opening of the second discharge opening 4a can be suppressed. (3) the discharging of the developer can rely dominantly on the discharging operation by the pump portion 3a. The inventors have investigated as to the size of the second discharge opening 4a not enough to discharge the toner to a sufficient extent only by the gravitation. The verification experiment (measuring method) and criteria will be described.

A rectangular parallelopiped container of a predetermined volume in which a discharge opening (circular) is formed at the center portion of the bottom portion is prepared, and is filled with 200 g of developer; then, the filling port is sealed, and the discharge opening is plugged; in this state, the container is shaken enough to loosen the developer. The rectangular parallelopiped container has a volume of 1000 cm̂3, 90 mm in length, 92 mm width and 120 mm in height.

Thereafter, as soon as possible the discharge opening is unsealed in the state that the discharge opening is directed downwardly, and the amount of the developer discharged through the discharge opening is measured. At this time, the rectangular parallelopiped container is sealed completely except for the discharge opening. In addition, the verification experiments were carried out under the conditions of the temperature of 24 degree C. and the relative humidity of 55%.

Using these processes, the discharge amounts are measured while changing the kind of the developer and the size of the discharge opening. In this example, when the amount of the discharged developer is not more than 2 g, the amount is negligible, and therefore, the size of the discharge opening at that time is deemed as being not enough to discharge the developer sufficiently only by the gravitation.

The developers used in the verification experiment are shown in Table 1. The kinds of the developer are one component magnetic toner, non-magnetic toner for two component developer developing device and a mixture of the non-magnetic toner and the magnetic carrier.

As for property values indicative of the property of the developer, the measurements are made as to angles of rest indicating flowabilities, and fluidity energy indicating easiness of loosing of the developer layer, which is measured by a powder flowability analyzing device (Powder Rheometer FT4 available from Freeman Technology).

TABLE 1

| | Volume | | | |
|---|---|---|---|---|
| | average | | | |
| | particle size | | Angle | Fluidity energy |
| | of toner | Developer | of rest | (Bulk density of |
| Developers | (μm) | component | (deg.) | 0.5 g/cm³) |
| A | 7 | Two-component | 18 | 2.09 × 10⁻³ J |
| | | non-magnetic | | |
| B | 6.5 | Two-component | 22 | 6.80 × 10⁻⁴ J |
| | | non-magnetic | | |
| | | toner + carrier | | |
| C | 7 | One-component | 35 | 4.30 × 10⁻⁴ J |
| | | magnetic toner | | |
| D | 5.5 | Two-component | 40 | 3.51 × 10⁻³ J |
| | | non-magnetic | | |
| | | toner + carrier | | |
| E | 5 | Two-component | 27 | 4.14 × 10⁻³ J |
| | | non-magnetic | | |
| | | toner + carrier | | |

Referring to FIG. 8, a measuring method for the fluidity energy will be described. Parts (a) and (b) of FIG. 8 are schematic views of a device for measuring fluidity energy. The principle of the powder flowability analyzing device is that a blade is moved in a powder sample, and the energy required for the blade to move in the powder, that is, the fluidity energy, is measured. The blade is of a propeller type, and when it rotates, it moves in the rotational axis direction simultaneously, and therefore, a free end of the blade moves helically.

The propeller type blade 54 is made of SUS (type=C210) and has a diameter of 48 mm, and is twisted smoothly in the counterclockwise direction. More specifically, from a center of the blade of 48 mm×10 mm, a rotation shaft extends in a normal line direction relative to a rotation plane of the blade, a twist angle of the blade at the opposite outermost edge portions (the positions of 24 mm from the rotation shaft) is 70°, and a twist angle at the positions of 12 mm from the rotation shaft is 35°.

The fluidity energy is total energy provided by integrating with time a total sum of a rotational torque and a vertical load when the helical rotating blade 54 enters the powder layer and advances in the powder layer. The value thus obtained indicates easiness of loosening of the developer powder layer, and large fluidity energy means less easiness and small fluidity energy means greater easiness.

In this measurement, as shown in FIG. 8, the developer T is filled up to a powder surface level of 70 mm (L2 in FIG. 8) into the cylindrical container 53 having a diameter φ of 50 mm (volume=200 cc, L1 (FIG. 8)=50 mm) which is the standard part of the device. The filling amount is adjusted in accordance with a bulk density of the developer to measure. The blade 54 of φ48 mm which is the standard part is advanced into the powder layer, and the energy required to advance from depth 10 mm to depth 30 mm is displayed.

The set conditions at the time of measurement are, The rotational speed of the blade 54 (tip speed=peripheral speed of the outermost edge portion of the blade) is 60 mm/s: The blade advancing speed in the vertical direction into the powder layer is such a speed that an angle θ (helix angle) formed between a track of the outermost edge portion of the blade 54 during advancement and the surface of the powder layer is 10°: The advancing speed into the powder layer in the perpendicular direction is 11 mm/s (blade advancement speed in the powder layer in the vertical direction=(rotational speed of blade)×tan (helix angle×n/180)): and The measurement is carried out under the condition of temperature of 24 degree C. and relative humidity of 55%.

The bulk density of the developer when the fluidity energy of the developer is measured is close to that when the experiments for verifying the relation between the discharge amount of the developer and the size of the discharge opening, is less changing and is stable, and more particularly is adjusted to be 0.5 g/cm̂3.

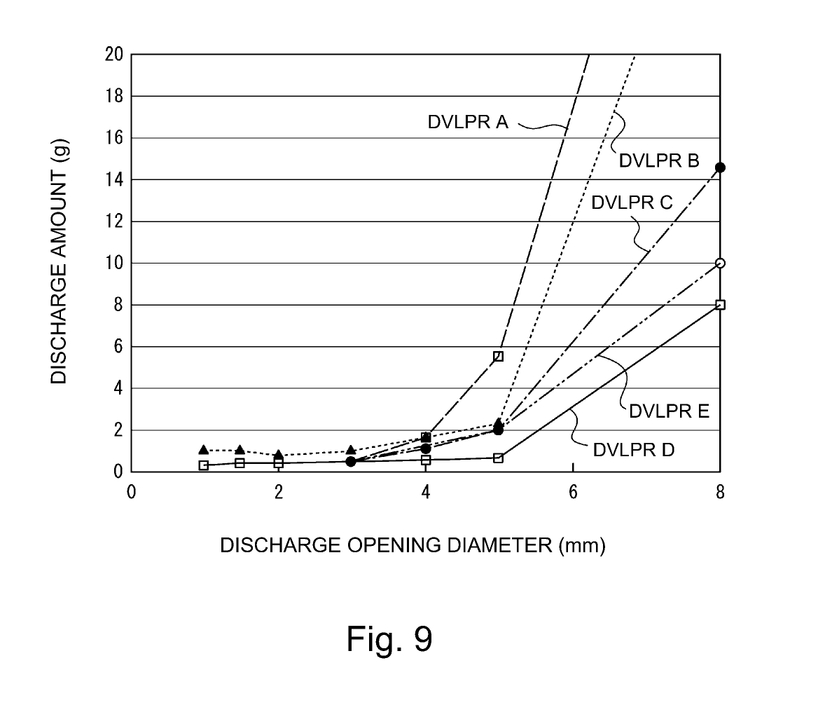

The verification experiments were carried out for the developers (Table 1) with the measurements of the fluidity energy in such a manner. FIG. 9 is a graph showing a relation between a diameter of a discharge opening and a discharge amount, for various developers.

From the verification results shown in FIG. 9, it has been confirmed that the discharge amount through the discharge opening is not more than 2 g for each of the developers A-E, if the diameter φ of the discharge opening is not more than 4 mm (12.6 mm̂2 in the opening area (circle ratio=3.14)). When the diameter φ discharge opening exceeds 4 mm, the discharge amount increases sharply. It will suffice if in the case that the fluidity energy of the developer (0.5 g/cm̂3 of the bulk density) is not less than 4.3×10̂-4 kg-m̂2/ŝ2 (J) and not more than 4.14×10̂-3 kg-m̂2/ŝ2 (J), the diameter of the second discharge opening 4a is not more than 4 mm (12.6 (mm̂2) of the opening area of the second discharge opening 4a).

As for the bulk density of the developer, the developer has been loosened and fluidized sufficiently in the verification experiments, and therefore, the bulk density is lower than that expected in the normal use condition (left state), that is, the measurements are carried out in the condition in which the developer is more easily discharged than in the normal use condition.

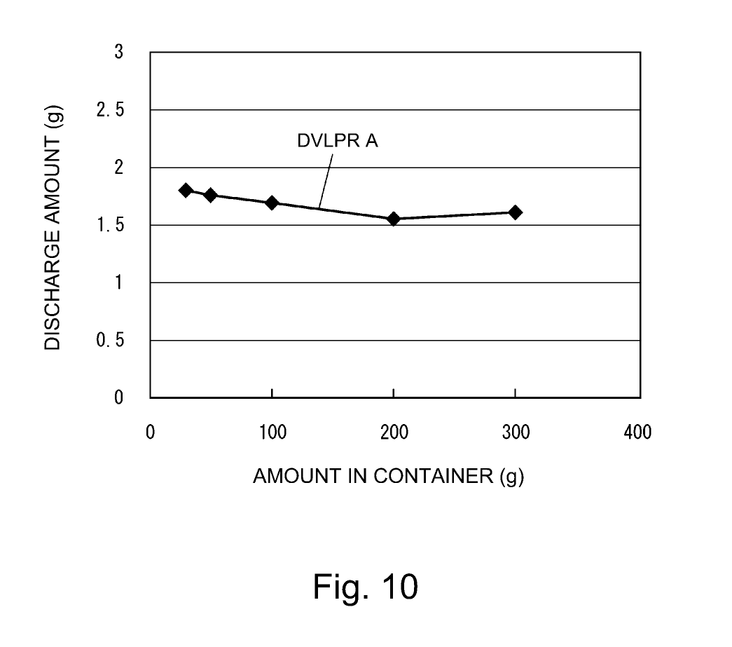

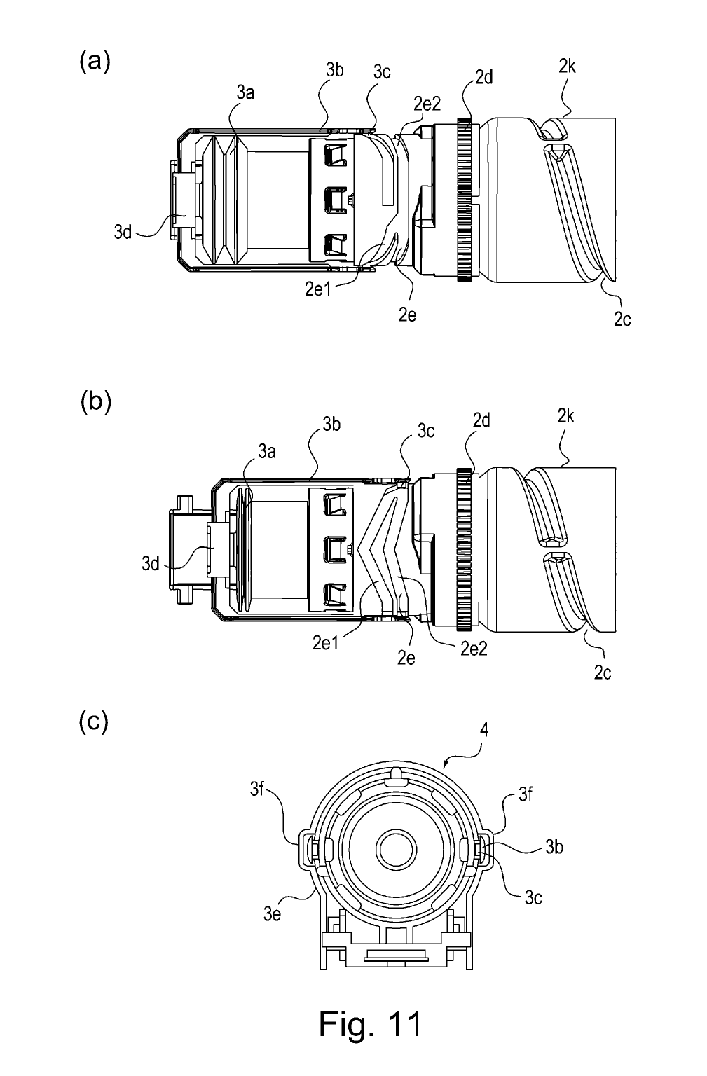

The verification experiments were carries out as to the developer A with which the discharge amount is the largest in the results of FIG. 9, wherein the filling amount in the container were changed in the range of 30-300 g while the diameter φ of the discharge opening is constant at 4 mm. The verification results are shown in FIG. 10. From the results of FIG. 10, it has been confirmed that the discharge amount through the discharge opening hardly changes even if the filling amount of the developer changes. From the foregoing, it has been confirmed that by making the diameter φ of the discharge opening not more than 4.0 mm (12.6 mm̂2 in the area), the developer is not discharged sufficiently only by the gravitation through the discharge opening in the state that the discharge opening is directed downwardly (supposed supplying attitude into the developer replenishing apparatus 201) irrespective of the kind of the developer or the bulk density state.

On the other hand, the lower limit value of the size of the second discharge opening 4a is preferably such that the developer to be supplied from the supply container 1 (one component magnetic toner, one component non-magnetic toner, two component non-magnetic toner or two component magnetic carrier) can at least pass therethrough. More particularly, the discharge opening is preferably larger than a particle size of the developer (volume average particle size in the case of toner, number average particle size in the case of carrier) contained in the supply container 1. For example, in the case that the supply developer comprises two component non-magnetic toner and two component magnetic carrier, it is preferable that the discharge opening is larger than a larger particle size, that is, the number average particle size of the two component magnetic carrier.

Specifically, in the case that the supply developer comprises two component non-magnetic toner having a volume average particle size of 5.5 μm and a two component magnetic carrier having a number average particle size of 40 μm, the diameter of the second discharge opening 4a is preferably not less than 0.05 mm (0.002 mm̂2 in the opening area).

If, however, the size of the second discharge opening 4a is too close to the particle size of the developer, the energy required for discharging a desired amount from the supply container 1, that is, the energy required for operating the pump portion 3a is large. It may be the case that a restriction is imparted to the manufacturing of the supply container 1. In order to mold the second discharge opening 4a in a resin material part using an injection molding method, a metal mold part for forming the second discharge opening 4a is used, and the durability of the metal mold part will be a problem. From the foregoing, the diameter φ of the second discharge opening 4a is preferably not less than 0.5 mm.

In this example, the configuration of the second discharge opening 4a is circular, but this is not inevitable. A square, a rectangular, an ellipse or a combination of lines and curves or the like are usable if the opening area is not more than 12.6 mm̂2 which is the opening area corresponding to the diameter of 4.0 mm.

However, a circular discharge opening has a minimum circumferential edge length among the configurations having the same opening area, the edge being contaminated by the deposition of the developer. However, a circular discharge opening has a minimum circumferential edge length among the configurations having the same opening area, the edge being contaminated by the deposition of the developer. In addition, with the circular discharge opening, a resistance during discharging is also small, and a discharging property is high. Therefore, the configuration of the second discharge opening 4a is preferably circular which is excellent in the balance between the discharge amount and the contamination prevention.

From the foregoing, the size of the second discharge opening 4a is preferably such that the developer is not discharged sufficiently only by the gravitation in the state that the second discharge opening 4a is directed downwardly (supposed supplying attitude into the developer replenishing apparatus 201). More particularly, a diameter φ of the second discharge opening 4a is not less than 0.05 mm (0.002 mm̂2 in the opening area) and not more than 4.0 mm (12.6 mm̂2 in the opening area). Furthermore, the diameter φ of the second discharge opening 4a is preferably not less than 0.5 mm (0.2 mm̂2 in the opening area and not more than 4 mm (12.6 mm̂2 in the opening area). In this example, on the basis of the foregoing investigation, the second discharge opening 4a is circular, and the diameter φ of the opening is 2 mm.

In this example, the number of the second discharge openings 4a is one, but this is not inevitable, and a plurality of discharge openings 4a, if the respective opening areas satisfy the above-described range. For example, in place of one developer receiving port 13 having a diameter φ of 3 mm, two second discharge openings 4a each having a diameter φ of 0.7 mm are employed. However, in this case, the discharge amount of the developer per unit time tends to decrease, and therefore, one second discharge opening 4a having a diameter φ of 2 mm is preferable.

### (Cylindrical Portion)

Referring to FIGS. 6, 7, the cylindrical portion 2k functioning as the developer accommodating chamber will be described. The cylindrical portion 2k as the developer accommodating chamber is a chamber capable of accommodating the developer. As soon in FIGS. 6 and 7, an inner surface of the cylindrical portion 2k is provided with a feeding portion 2c which is projected and extended helically, the feeding projection 2c functioning as a feeding portion for feeding the developer accommodated in the developer accommodating portion 2 toward the discharging portion 4c (second discharge opening 4a) functioning as the developer discharging chamber, with rotation of the cylindrical portion 2k. The cylindrical portion 2k is formed by a blow molding method from an above-described resin material.

As shown in part (b) of FIG. 7, the cylindrical portion 2k is supported rotatably relative to the flange portion 4 with a flange seal 5b of a ring-like sealing member provided on the inner surface of the flange portion 4 being compressed.

By this, the cylindrical portion 2k rotates while sliding relative to the flange seal 5b, and therefore, the developer does not leak out during the rotation, and a hermetical property is provided. Thus, the air can be brought in and out through the second discharge opening 4a, so that desired states of the volume change of the supply container 1 during the developer supply can be accomplished.

### (Pump Portion)

Referring to FIG. 7, the description will be made as to the pump portion (reciprocable pump) 3a in which the volume thereof changes with reciprocation.

The pump portion 3a of this example functions as a suction and discharging mechanism for repeating the sucking operation and the discharging operation alternately through the second discharge opening 4a. In other words, the pump portion 3a functions as an air flow generating mechanism for generating repeatedly and alternately air flow into the supply container and air flow out of the supply container through the second discharge opening 4a.

The pump portion 3a is a part in which the inner volume of the cylindrical portion 2k can be changed in the longitudinal direction of the supply container 1 to apply a pressure at least to the second discharge opening 4a. As shown in part (b) of FIG. 7, the pump portion 3a is provided at a position away from the discharging portion 4c in a direction X. Thus, the pump portion 3a does not rotate in the rotational direction of the cylindrical portion 2k together with the discharging portion 4c.

In this example, the pump portion 3a is a displacement type pump (bellow-like pump) of resin material in which the volume thereof changes with the reciprocation. More particularly, as shown in part (b) of FIG. 7, the bellow-like pump includes crests and bottoms periodically and alternately. Therefore, the pump portion 2b repeats the compression and the expansion alternately by the driving force received from the developer replenishing apparatus 201. Using the pump portion 3a of such a structure, the volume of the supply container 1 can be alternately changed repeatedly at predetermined intervals. As a result, the developer in the discharging portion 4c can be discharged efficiently through the small diameter second discharge opening 4a (diameter of approx. 2 mm).

### (Suppressing Portion)

As described in the foregoing, referring to part (a) of FIG. 7 and part (b) of FIG. 7, the partition 20 for isolation between the discharging portion 4c and the pump portion 3a is provided adjacent to the connecting portion between the pump portion 3a and the discharging portion 4c of the supply container 1. The partition 20 as the suppressing portion is provided at the connecting portion between the pump portion 3a and the discharging portion 4c, and at least in the discharging operation, the partition 20 functions to suppress the flow of the air produced by the pump portion 3a toward the cylindrical portion 2k.

In addition, as shown in part (c) of FIG. 7, a part of the partition 20 constitutes the fluid communication path 20a for fluid communication with the storage portion 4d. The fluid communication path 20a as the air hole portion is a passage for fluid communication between the pump portion 3a and the storage portion 4d. That is, the pump portion 3a is in fluid communication with the second discharge opening 4a or the discharging portion 4c through the fluid communication path 20a and the storage portion 4d. Therefore, when the pump portion 3a is compressed as described above, the produced air flow toward the outside is directed first to the storage portion 4d along the arrow shown in part (c) of FIG. 7, and then most of the air is discharged to the outside through the second discharge opening 4a.

Similarly, when the pump portion 3a is expanded, the produced air flow toward the inside of the supply container 1 is taken in first through the second discharge opening 4a in the direction opposite to that of the arrow as shown in part (c) of FIG. 7 and then sucked into the pump portion 3a through the fluid communication path 20a from the storage portion 4d. That is, in the supply container 1 of this embodiment, the air flow taken in and discharged out through the second discharge opening 4a flows through the fluid communication path 20a mainly between the pump portion 3a, the storage portion 4d and the second discharge opening 4a. Therefore, in the supply container 1 of this embodiment, the air flow produced by the pump portion 3a does not expand to the entirety of the discharging portion 4c or the cylindrical portion 2k, so that the pressure difference from the supply container 1 is locally large adjacent to the storage portion 4d.

In addition, the volume of the storage portion 4d is relatively very small as compared with that of the discharging portion 4c or the cylindrical portion 2k, and therefore, the local pressure difference produced in the neighborhood of the developer storage portion is very high as compared with the case of the conventional example of the supply container 1 in which the air flow is directed to the entirety of the developer accommodating space.

### (Drive Receiving Mechanism)

The description will be made as to a drive receiving mechanism (drive receiving portion, driving force receiving portion) of the supply container 1 for receiving the rotational force for rotating the cylindrical portion 2k provided with feeding projection 2c from the developer replenishing apparatus 201. As shown in part (a) of FIG. 6, the supply container 1 is provided with a gear portion 2a which functions as a drive receiving mechanism (drive receiving portion, driving force receiving portion) engageable (driving connection) with a driving gear 300 (functioning as driving mechanism) of the developer replenishing apparatus 201. The gear portion 2d as the driving force receiving portion receives a rotational force for rotating the inclination rib 6a from the driving gear 300 of the supplying device 201.

Therefore, the rotational force inputted to the gear portion 2d from the driving gear 300 (FIG. 6) is transmitted to the pump portion 3a through a reciprocation member 3b shown in part (a) and (b) of FIG. 11, as will be described in detail hereinafter. The bellow-like pump portion 3a of this example is made of a resin material having a high property against torsion or twisting about the axis within a limit of not adversely affecting the expanding-and-contracting operation.

In this example, the gear portion 2d is provided at one longitudinal end (developer feeding direction) of the cylindrical portion 2k, but this is not inevitable, and the gear portion 2a may be provided at the other longitudinal end side of the developer accommodating portion 2, that is, the trailing end portion. In such a case, the driving gear 300 is provided at a corresponding position.

In this example, a gear mechanism is employed as the driving connection mechanism between the gear portion 2d of the supply container 1 and the gear 300 of the developer replenishing apparatus 201, but this is not inevitable, and a known coupling mechanism, for example is usable. More particularly, in such a case, the structure may be such that a non-circular recess is provided as a drive receiving portion, and correspondingly, a projection having a configuration corresponding to the recess as a driver for the developer replenishing apparatus 201, so that they are in driving connection with each other.

### (Drive Converting Mechanism)

Referring to FIG. 11, a drive converting mechanism (drive converting portion) for the supply container 1 will be described. In this example, a cam mechanism is taken as an example of the drive converting mechanism. Part (a) of FIG. 11 is a partial view in a state in which the pump portion is expanded to the maximum usable limit, (b) is a partial view in a state in which the pump portion is contracted to the maximum usable limit, and (c) is a partial view of the pump portion. As shown in part (a) of FIG. 11, the supply container 1 is provided with the cam mechanism which functions as the driving force converting mechanism for converting the rotational force for rotating the cylindrical portion 2k received by the gear portion 2d to a force in the reciprocating directions of the pump portion 3a.

In this example, one drive receiving portion (gear portion 2d) receives the driving force for rotating the cylindrical portion 2k and for reciprocating the pump portion 3a, and the rotational force received by converting the rotational driving force received by the gear portion 2d to a reciprocation force in the supply container 1 side.

Because of this structure, the structure of the drive receiving mechanism for the supply container 1 is simplified as compared with the case of providing the supply container 1 with two separate drive receiving portions. In addition, the drive is received by a single driving gear of developer replenishing apparatus 201, and therefore, the driving mechanism of the developer replenishing apparatus 201 is also simplified.

As shown in part (a) of FIG. 11 and part (b) of FIG. 11, the used member for converting the rotational force to the reciprocation force for the pump portion 3a is the reciprocation member 3b. More specifically, it includes a rotatable cam groove 2e extended on the entire circumference of the portion integral with the driven receiving portion (gear portion 2d) for receiving the rotation from the driving gear 300. The cam groove 2e will be described hereinafter. The cam groove 2e is engaged with a reciprocation member engaging projection projected from the reciprocation member 3b.

The cam groove 2e and the reciprocation member 3b as driving force converting portion converts the received rotational force into a feeding driving force to rotate the inclination rib 6a through the gear portion 2d to feed the developer by the operation of the pump portion 3a in the longitudinal direction of the supply container 1. In this example, as shown in part (c) of FIG. 11, the reciprocation member 3b is limited in the movement in the rotational moving direction of the cylindrical portion 2k by a protecting member rotation regulating portion 3f (play will be permitted) so that the reciprocation member 3b does not rotate in the rotational direction of the cylindrical portion 2k. By the movement in the rotational moving direction limited in this manner, it reciprocates along the groove of the cam groove 2e (in the direction of the arrow X shown in FIG. 7 or the opposite direction).

A plurality of such reciprocation member engaging projections 3c are provided and are engaged with the cam groove 2e. More particularly, two engaging projections 3c are provided opposed to each other in the diametrical direction of the cylindrical portion 2k (approx. 180° opposing). The number of the engaging projections 3c is satisfactory if it is not less than one. However, in consideration of the liability that a moment is produced by the drag force during the expansion and contraction of the pump portion 3a with the result of unsmooth reciprocation, the number is preferably plural as long as the proper relation is assured in relation to the configuration of the cam groove 2e which will be described hereinafter.

In this manner, by the rotation of the cam groove 2e by the rotational force received from the driving gear 300, the reciprocation member engaging projection 3c reciprocates in the arrow X direction and the opposite direction along the cam groove 2e. By this, the pump portion 3a repeats the expanded state (part (a) of FIG. 11) and the contracted state (part (b) of FIG. 11) alternately, thus changing the volume of the supply container 1.

### (Set Conditions of Drive Converting Mechanism)

In this example, the driving force converting mechanism effects the drive conversion such that an amount (per unit time) of developer feeding to the discharging portion 4c by the rotation of the cylindrical portion 2k is larger than a discharging amount (per unit time) to the developer replenishing apparatus 201 from the discharging portion 4c by the function of the pump portion.

This is because if the developer discharging power of the pump portion 2b is higher than the developer feeding power of the feeding projection 2c to the discharging portion 3h, the amount of the developer existing in the discharging portion 3h gradually decreases. In other words, it is avoided that the time period required for supplying the developer from the supply container 1 to the developer replenishing apparatus 201 is prolonged.

In addition, in the drive converting mechanism of this example, the drive conversion is such that the pump portion 3a reciprocates a plurality of times per one full rotation of the cylindrical portion 2k. This is for the following reasons.

In the case of the structure in which the cylindrical portion 2k is rotated inner the developer replenishing apparatus 201, it is preferable that the driving motor 500 is set at an output required to rotate the cylindrical portion 2k stably at all times. However, from the standpoint of reducing the energy consumption in the image forming apparatus 100 as much as possible, it is preferable to minimize the output of the driving motor 500. The output required by the driving motor 500 is calculated from the rotational torque and the rotational frequency of the cylindrical portion 2k, and therefore, in order to reduce the output of the driving motor 500, the rotational frequency of the cylindrical portion 2k is minimized.

However, in the case of this example, if the rotational frequency of the cylindrical portion 2k is reduced, a number of operations of the pump portion 3a per unit time decreases, and therefore, the amount of the developer (per unit time) discharged from the supply container 1 decreases. In other words, there is a possibility that the developer amount discharged from the supply container 1 is insufficient to quickly meet the developer supply amount required by the main assembly of the image forming apparatus 100.

If the amount of the volume change of the pump portion 3a is increased, the developer discharging amount per unit cyclic period of the pump portion 3a can be increased, and therefore, the requirement of the main assembly of the image forming apparatus 100 can be met, but doing so gives rise to the following problem. If the amount of the volume change of the pump portion 2b is increased, a peak value of the internal pressure (positive pressure) of the supply container 1 in the discharging stroke increases, and therefore, the load required for the reciprocation of the pump portion 2b increases.

For this reason, in this example, the pump portion 3a operates a plurality of cyclic periods per one full rotation of the cylindrical portion 2k. By this, the developer discharge amount per unit time can be increased as compared with the case in which the pump portion 3a operates one cyclic period per one full rotation of the cylindrical portion 2k, without increasing the volume change amount of the pump portion 3a. Corresponding to the increase of the discharge amount of the developer, the rotational frequency of the cylindrical portion 2k can be reduced. With the structure of this example, the required output of the driving motor 500 may be low, and therefore, the energy consumption of the main assembly of the image forming apparatus 100 can be reduced.

### (Position of Driving Converting Mechanism)

As shown in FIG. 11, in this example, the driving force converting mechanism (cam mechanism constituted by the engaging projection 3c and cam groove 2e) is provided outside of developer accommodating portion 2. More particularly, the driving force converting mechanism is disposed at a position separated from the inside spaces of the cylindrical portion 2k, the pump portion 3a and the discharging portion 4c, so that the driving force converting mechanism does not contact the developer accommodated inside the cylindrical portion 2k, the pump portion 3 and the discharging portion 4.

By this, a problem which may arise when the driving force converting mechanism is provided in the inside space of the developer accommodating portion 2 can be avoided. More particularly, the problem is that by the developer entering portions of the driving force converting mechanism where sliding motions occur, the particles of the developer are subjected to heat and pressure to soften and therefore, they agglomerate into masses (coarse particle), or they enter into a converting mechanism with the result of torque increase. The problem can be avoided. Now, the description will be made as to the developer supplying step into the developer supplying apparatus 201 by the supply container 1.

### (Developer Supplying Step)

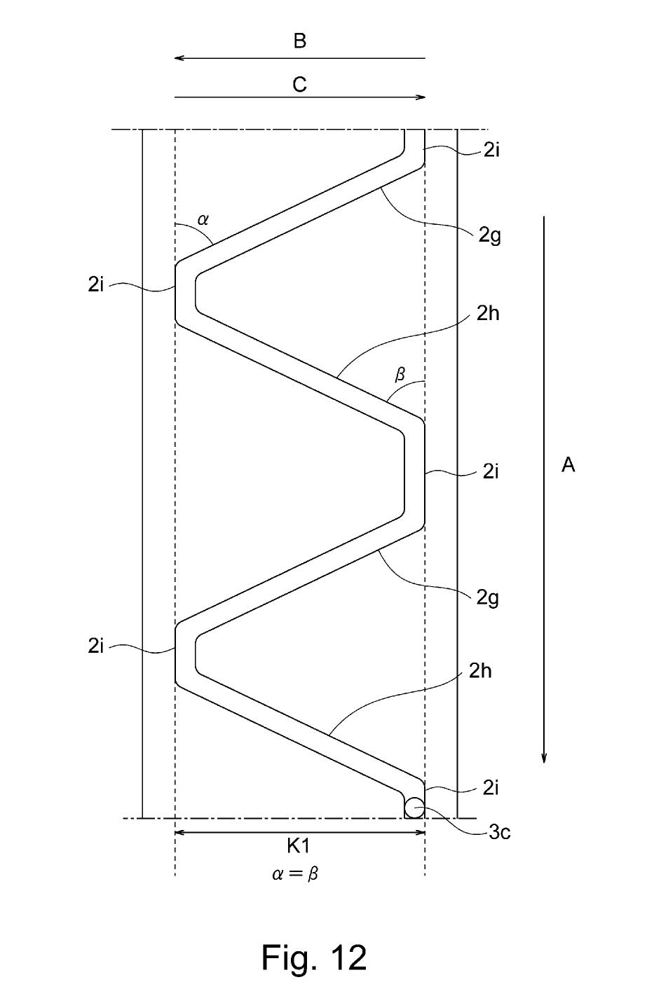

Referring to FIGS. 11 and 12, a developer supplying step by the pump portion 3a will be described. FIG. 12 is an extended elevation illustrating a cam groove 21, in the above-described driving force converting mechanism (cam mechanism including the engaging projection 3c and the cam groove 2e. The details of the cam groove 2e will be described hereinafter.

In this example, as will be described hereinafter, the drive conversion of the rotational force is carries out by the driving force converting mechanism so that the suction stroke by the pump operation (suction operation through the second discharge opening 4a), the discharging stroke (discharging operation through the second discharge opening 4a) and the rest stroke by the non-operation of the pump portion (neither suction nor discharging is effected through the second discharge opening 4a) are repeated alternately. The suction stroke, the discharging stroke and the rest stroke will be described.

### (Suction Stroke)

First, the suction stroke (suction operation through the first discharge opening 4e and the second discharge opening 4a) will be described. The above-described drive converting mechanism (cam mechanism) effects the sucking operation by changing the pump state from the most contracted state of the pump portion 3a shown in part (b) of FIG. 11 to the most expanded state of the pump portion 3a shown in part (a) of FIG. 11. The inside of the supply container 1 is substantially in sealed state except for the second discharge opening 4a, and the second discharge opening 4a is substantially closed by the developer T existing there. Therefore, with the increase of the inside volume of the supply container 1, the internal pressure of the supply container 1 decreases.

At this time, the internal pressure of the supply container 1 (local internal pressure in the neighborhood of the storage portion 4d and the inside of the pump portion 3a) becomes lower than the ambient pressure (external air pressure). Therefore, the air outside the supply container 1 flows into the inside of the supply container 1 through the second discharge opening 4a by the pressure difference between the inside and outside of the supply container 1. More particularly, as described hereinbefore, the air through the second discharge opening 4a under the provision of the partition 20 and the fluid communication path 20a moves into the pump portion 3a through the storage portion 4d and the fluid communication path 20a in the order named. At this time, the air is hardly directed toward the discharging portion 4c.

Because the air is taken into the inside of the supply container 1 through the second discharge opening 4a from the outside, the developer in the storage portion 4d existing above the second discharge opening 4a is loosened (fluidized). More particularly, the bulk density of the developer in the storage portion 4d decreases by the introduction of the air therein, so that the developer T is fluidized properly.

In this embodiment, by the provision of the partition 20, the air taken in through the second discharge opening 4a does not scatter into the discharging portion 4c, but is supplied directly into the pump portion 3a from the inside of the storage portion 4d. Therefore, in the supply container 1, the air flow produced by the pump portion 3a does not scatter to the entirety of the discharging portion 4c and/or the cylindrical portion 2k. As a result, the pressure difference from the outside of the supply container 1 is locally large adjacent to the storage portion 4d.

Because of the volume of the storage portion 4d is very small as compared with the discharging portion 4c and the cylindrical portion 2k, the above-described local pressure difference produced adjacent to the storage portion 4d is very high as compared with the case of the conventional example structure in which the air flow is distributed to the entirety of the accommodation space. Therefore, even when the developer in the storage portion 4d is packed due to the vibration or the like during the transportation, the developer can be assuredly fluidized. In addition, because the air is introduced in the supply container 1 through the second discharge opening 4a, the internal pressure of the supply container 1 is kept close to the ambient pressure (external air pressure) despite the increase of the volume.

By the fluidization of the developer in this manner, the possible packing of the developer T in the second discharge opening 4a during the discharging operation which will be described hereinafter can be prevented, so that the developer can be smoothly discharged through the second discharge opening 4a. Therefore, the amount of the developer T discharged through the second discharge opening 4a (amount per unit time) can be made substantially constant for a long-term.

This is not limited to the case that the suction operation is from the most contracted state to the most expanded state of the pump portion 3a, the suction operation is carried out even when the pump portion 3a stops partway, if the change of the internal pressure of the supply container 1 occurs. That is, the suction stroke is the state in which the engaging projection 3c is in engagement with the cam groove 2h shown in FIG. 12.

### (Discharging Stroke)

The description will be made as to the discharging stroke (discharging operation through the second discharge opening 4a). The discharging operation is effected by the change of the state of the pump portion 3a from the most the expanded state shown in part (a) of FIG. 11 to the most contracted state shown in part (b) of FIG. 11. More particularly, by the discharging operation, the volume of the supply container 1 decreases. At this time, the inside of the supply container 1 is substantially sealed except for the second discharge opening 4a, and therefore, the second discharge opening 4a is substantially closed by the developer T before the developer is discharged. Therefore, by compressing the pump portion 3a, the internal pressure of the supply container 1 increases.

At this time, the internal pressure of the supply container 1 becomes higher than the ambient pressure (external air pressure), so that the developer T is discharged through the second discharge opening 4a by the pressure difference between the inner and outer of the supply container 1. In this embodiment, as described hereinbefore, the storage portion 4d of the pump portion 3a is in fluid communication with the second discharge opening 4a through the fluid communication path 20a formed by the partition 20 as described hereinbefore. Therefore, the air flow toward the outside produced by the compression of the pump portion 3a is hardly scattered in the discharging portion 4c but is concentrated on the storage portion 4d. Therefore, the developer T in the storage portion 4d fluidized by the suction stroke can be stably discharged. In addition, the air in the supply container 1 is also discharged together with the developer T, and therefore, the internal pressure of the supply container 1 decreases.

In the above-described the manner, according to this embodiment, by the provision of the partition 20, the air works efficiently to the storage portion 4d. As a result, as compared with the conventional supply container 1, the developer T can be stably discharged using a small amount of discharging air.

For effecting the discharging operation, it is not inevitable that the pump portion 3a changes from the most expanded state to the most contracted state, but the discharging operation is effected if the internal pressure of the supply container 1 changes even if the pump portion changes from the most expanded state halfway to the most contracted state. That is, the discharging stroke corresponds to the state in which the reciprocation member engaging projection 3c is engaged with the cam groove 2 g shown in FIG. 12.

### (Rest Stroke)

The rest stroke in which the pump portion 3a does not to reciprocate will be described. In this example, as described hereinbefore, the operation of the driving motor 500 is controlled by the control device 600 on the basis of the results of the detection of the magnetometric sensor 800c and/or the developer sensor 10d. With such a structure, the amount of the developer discharged from the supply container 1 directly influences the toner content of the developer, and therefore, it is desirable to supply the amount of the developer required by the image forming apparatus from the supply container 1. At this time, in order to stabilize the amount of the developer discharged from the supply container 1, it is desirable that the amount of volume change at one time is constant.

If, for example, the cam groove 2e includes only the portions for the discharging stroke and the suction stroke, the motor actuation may stop at halfway of the discharging stroke or suction stroke. After the stop of the driving motor 500, the cylindrical portion 2k continues rotating by the inertia, by which the pump portion 3a continues reciprocating until the cylindrical portion 2k stops, during which the discharging stroke or the suction stroke continues. The distance through which the cylindrical portion 2k rotates by the inertia is dependent on the rotational speed of the cylindrical portion 2k. Further, the rotational speed of the cylindrical portion 2k is dependent on the torque applied to the driving motor 500. From this, the torque to the motor changes depending on the amount of the developer in the supply container 1, and the speed of the cylindrical portion 2k may also change, and therefore, it is difficult to stop the pump portion 3a at the same position.

In order to stop the pump portion 3a at the same position, a region in which the pump portion 3a does not reciprocate even during the rotation of the cylindrical portion 2k is desired to be provided in the cam groove 2e. In this embodiment, for the purpose of preventing the reciprocation of the pump portion 3a, there is provided a cam groove 2i (FIG. 12). The cam groove 2i extends in the rotational moving direction of the cylindrical portion 2k, and therefore, the reciprocation member 3b does not move despite the rotation (straight shape). That is, the rest stroke corresponds to the reciprocation member engaging projection 3c engaging with the cam groove 2i.

The non-reciprocation of the pump portion 3a means that the developer is not discharged through the second discharge opening 4a (except for the developer falling through the second discharge opening 4a due to the vibration or the like during the rotation of the cylindrical portion 2k). Thus, if the discharging stroke or suction stroke through the second discharge opening 4a is not effected, the cam groove 2i may be inclined relative to the rotational moving direction toward the rotation axial direction. When the cam groove 2i is inclined, the reciprocation of the pump portion 3a corresponding to the inclination is permitted.

### (Change of Internal Pressure of Supply Container)

Verification experiments were carried out as to a change of the internal pressure of the supply container 1. The verification experiments will be described. The developer is filled such that the developer accommodating space in the supply container 1 is filled with the developer; and the change of the internal pressure of the supply container 1 is measured when the pump portion 3a is expanded and contracted in a range of 5 cm̂3 of volume change. The internal pressure of the supply container 1 is measured using a pressure gauge (AP-C40 available from Kabushiki Kaisha KEYENCE) connected with the supply container 1.

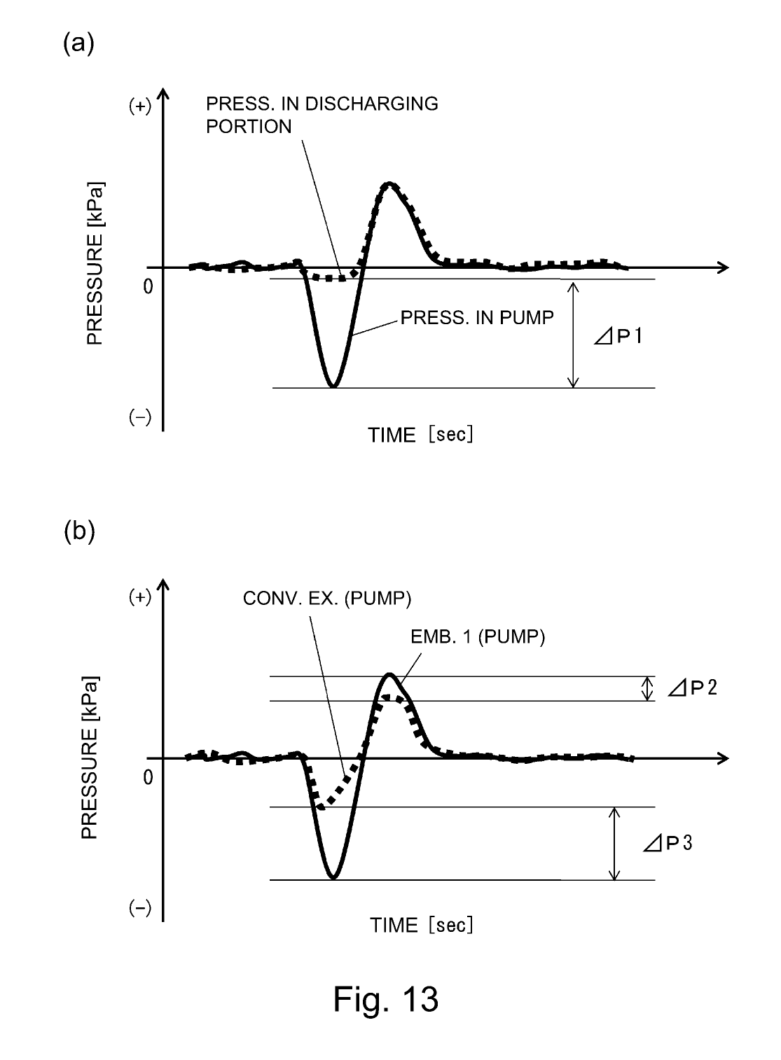

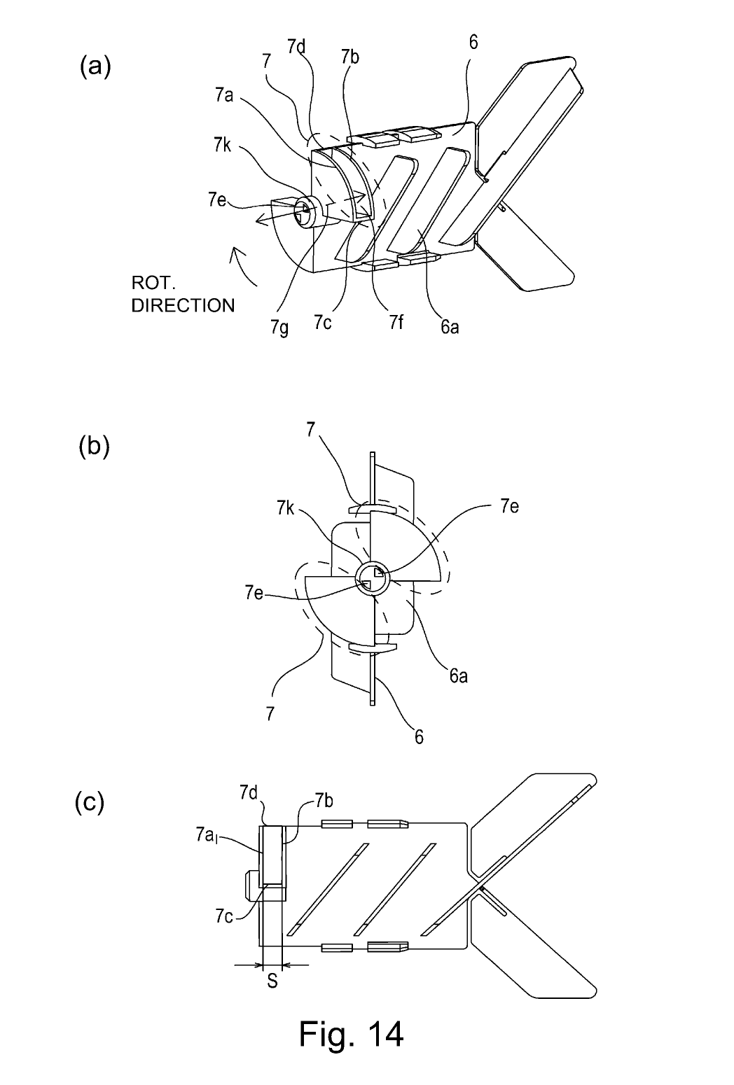

Part (a) of FIG. 13 is a graph showing the pressure change when the pump portion 3a is expanded and contracted in the state the shutter 4b of the supply container 1 is open so that the second discharge opening 4a is in fluid communication with the outside. The ordinate is a relative pressure [kPa] of the inside of the supply container 1 to the ambient pressure (reference pressure (1 kPa)). Here, “+” means the positive pressure, and “−” means the negative pressure. The abscissa is the time [sec]. In part (a) of FIG. 13, the solid line shows the change of the pressure in the pump portion 3a (nearly equal to the pressure applied to the storage portion 4d), and the broken line shows the change of the pressure in the discharging portion 4c.

When the volume of the supply container 1 increases, the pressure of the supply container 1 becomes negative relative to the outside ambient pressure, and the air is taken in through the second discharge opening 4a by the pressure difference. When the volume of the supply container 1 decreases, the internal pressure of the supply container 1 becomes positive relative to the ambient pressure, so that the pressure is applied to the inside developer. At this time, the internal pressure is eased correspondingly to the amount of the discharged air and developer.

By the experiments, it has been confirmed that when the volume of the supply container 1 increases, the internal pressure of the supply container 1 becomes negative relative to the outside ambient pressure, and the air is taken in by the pressure difference. With the supply container 1 of the embodiment, it has been confirmed that the negative pressure inside the pump portion 3a and the discharging portion 4c is such that the pressure in the pump portion 3a is higher by delta P1. That is, by the provision of the partition 20 between the pump portion 3a and the discharging portion 4c and the provision of the fluid communication path 20a directly communicating the pump portion 3a and the storage portion 4d with each other, the air flow produced by the pump portion 3a is applied to the storage portion 4d.

Part (b) of FIG. 13 is a graph showing the results of the similar experiments with the conventional supply container. As shown in part (b) of FIG. 13, the internal pressure of the pump portion 3a of the supply container 1 is compared between this embodiment and conventional example. The ordinate and the abscissa in part (b) of FIG. 13 are the same as those in part (a) of FIG. 13. As will be evident from the graph of part (b) of FIG. 13, as compared with the conventional supply container, the pressure relative to the ambient pressure is larger by ΔP2 in the positive side and ΔP3 in the negative side. That is, with the supply container 1 of the embodiment, it has been confirmed that the higher pressure air can be applied to the developer in the storage portion 4d as compared with the conventional supply container.

As described hereinbefore, according to the supply container 1 of this Embodiment 1, by the provision of the partition 20, the air flow produced by the expanding-and-contracting operation of the pump portion 3a act on the storage portion 4d efficiently. Therefore, as compared with the case of the conventional supply container, the inside of the storage portion 4d can be easily pressurized to fluidize the developer T.

### Embodiment 2

Part (a) of FIG. 18 is a perspective view of the flange portion 4 of the supply container 1 according to Embodiment 2, as seen from the accommodating portion 2. Part (b) of FIG. 18 is a sectional view of the flange portion 4. The supply container 1 of Embodiment 2 is different from the supply container 1 of Embodiment 1 in the partition 20, the fluid communication path 20a and the feeding member 6.

As shown in part (b) of FIG. 18, the flange portion 4 is provided with a partition 20 as the suppressing portion as a partition between the pump portion 3a and the accommodating portion 2. The partition 20 is provided with an annular rib 20b substantially at the center on the accommodating portion 2 side. The annular rib 20b is provided with a shaft sealing member 22 on the inside surface of the annular rib 20b. Inside of the annular rib 20b, there is provided a fluid communication path 20a. The fluid communication path 20a permits air flow the through together with the pump portion 3a, an opening 7e which will be described hereinafter, and the storage portion 4d.

The fluid communication path 20a is semicircle shape having an arcuation in the storage portion 4d side (lower side). In this embodiment, the shaft sealing member 22 is an oil seal (available from NOK Kabushiki Kaisha, Japan) which is engaged with a cylindrical shaft portion 7k of the feeding member 6 as will be described hereinafter to prevent leakage of the developer and the air. The shaft sealing member 22 may be sponge-like material such as urethane foam or the like to prevent the developer and/or the air.

Or, the clearance between the outer diameter of the cylindrical shaft portion 7k and the inner diameter of the annular rib 20b can be made so small that the developer and/or air leakage is suppressed. The other structures of the flange portion 4 are the same as those of Embodiment 1.

(Regulating Portion)

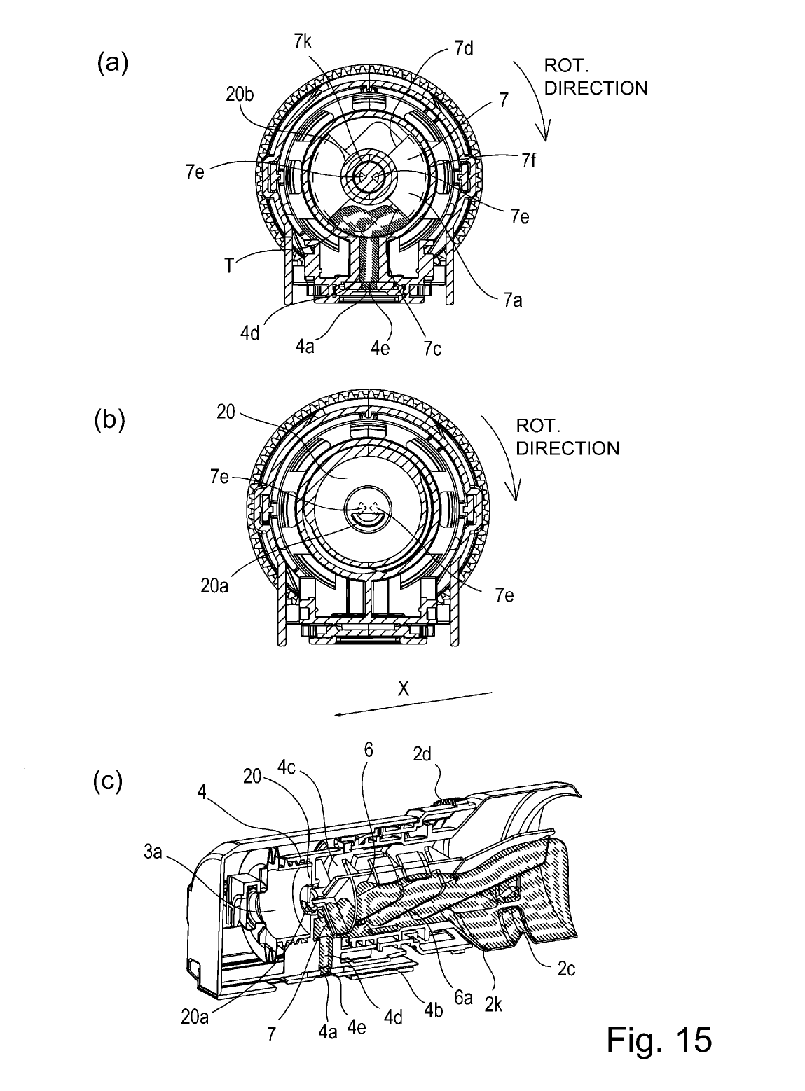

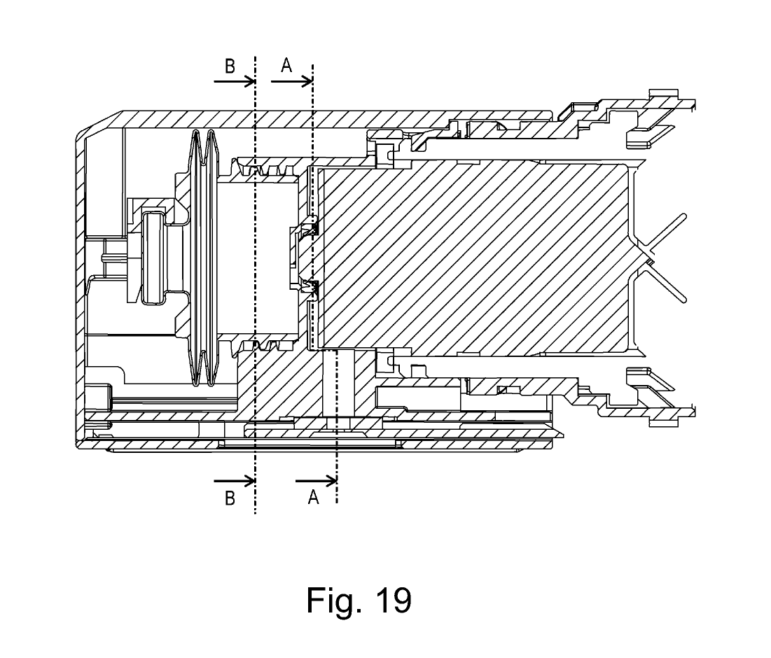

The regulating portion 7 of this embodiment will be described. Referring to FIGS. 18, 14, 15, 16, 17 and 19, the detailed description will be made. Part (a) of FIG. 14 is a perspective view of the feeding member 6 provided in the supply container 1. Part (b) of FIG. 14 it is a side view of the feeding member 6. Part (c) of FIG. 14 is a front view of the feeding member 6. In the FIGS. 15, 16 and 17, parts (a) are A-A sectional views of FIG. 19, illustrating the inside of the supply container 1 as seen from the pump portion 3a side of FIG. 19, in the supplying operation. In FIGS. 15, 16 and 17, parts (b) are B-B sectional views of FIG. 19, illustrating that the inside of the supply container 1 in the supplying operation.

As shown in part (a) of FIG. 14, the regulating portion 7 is provided integrally at a pump portion 3a side of the feeding member 6. Therefore, the regulating portion 7 rotates with the feeding member 6 which integrally rotates with the cylindrical portion 2k. The regulating portion 7 is a portion movable between the regulating position full limiting the flow of the developer into the storage portion 4d and the non-regulating position in which the flow of the developer into the storage portion 4d is not limited.

The regulating portion 7 includes thrust walls 7a and 7b and radial walls 7c and 7d.

The thrust walls 7a and 7b are respective walls parallel with each other with a gap S therebetween measured in the direction of the rotational axis (part (c) of FIG. 14). The radial walls 7c and 7d are respective walls having surfaces facing the in the circumferential direction of rotation. A storage portion opening 7f communicatable with the storage portion 4d is provided by two thrust walls 7a and 7b and radially outside end portions of two radial walls 7c and 7d.

That is, the position of the rotation shaft of the storage portion opening 7f is such that the storage portion opening 7f overlaps at least partly with the storage portion 4d. The cylindrical shaft portion 7k is formed in the neighborhood of the rotation axis of the pump portion 3a side on the thrust wall 7a and is inserted into the shaft sealing member 22 of the annular rib 20b to support the feeding member 6.

The pump portion 3a side end surface of the cylindrical shaft portion 7k is provided with an opening 7e in fluid communication with the storage portion opening 7f. A regulating portion 7 is a portion surrounded by the two thrust walls 7a, 7b and the radial walls 7c, 7d, and a fluid communication path 7g for establishing fluid communication between the opening 7e and the storage portion opening 7f is provided by the inside of the regulating portion 7. The regulating portion 7 moves to the regulating position in the discharging operation of the pump portion 3a to cover at least a part of the storage portion 4d to guide the air flow provided by the pump portion 3a. The fluid communication path 7g is a space surrounded by the thrust walls 7a, 7b and the radial walls 7c, 7d at the position indicated by the broken lines in part (a) of FIG. 14. That is, the fluid communication path 7g as the air hole portion is formed in a part of the regulating portion 7. The opening 7e is capable of being in fluid communication with the storage portion 4d the fluid communication path 7g and the storage portion opening 7f.

Referring to FIGS. 15, 16, 17 and 18, the operation of the regulating portion 7 in the developer supplying step will be described. FIG. 15 shows the state of the supply container in the operation rest step in which the pump portion 3a does not operate. In this case, the regulating portion 7 rotates with the rotation of the feeding member 6, but the storage portion opening 7f of the regulating portion 7 does not cover the first discharge opening 4e and the second discharge opening 4a formed in the bottom portion of the discharging portion 4c. The pump portion 3a does not reciprocate, and the internal pressure in the neighborhood of the storage portion 4d does not change.

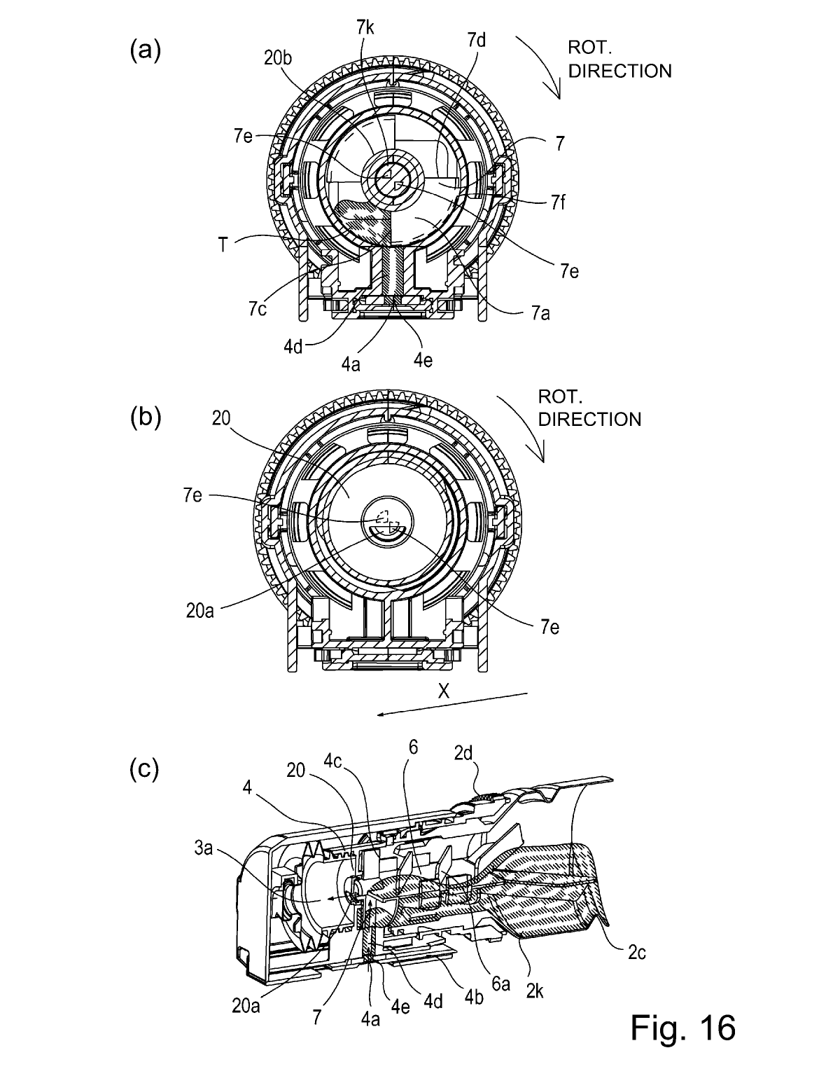

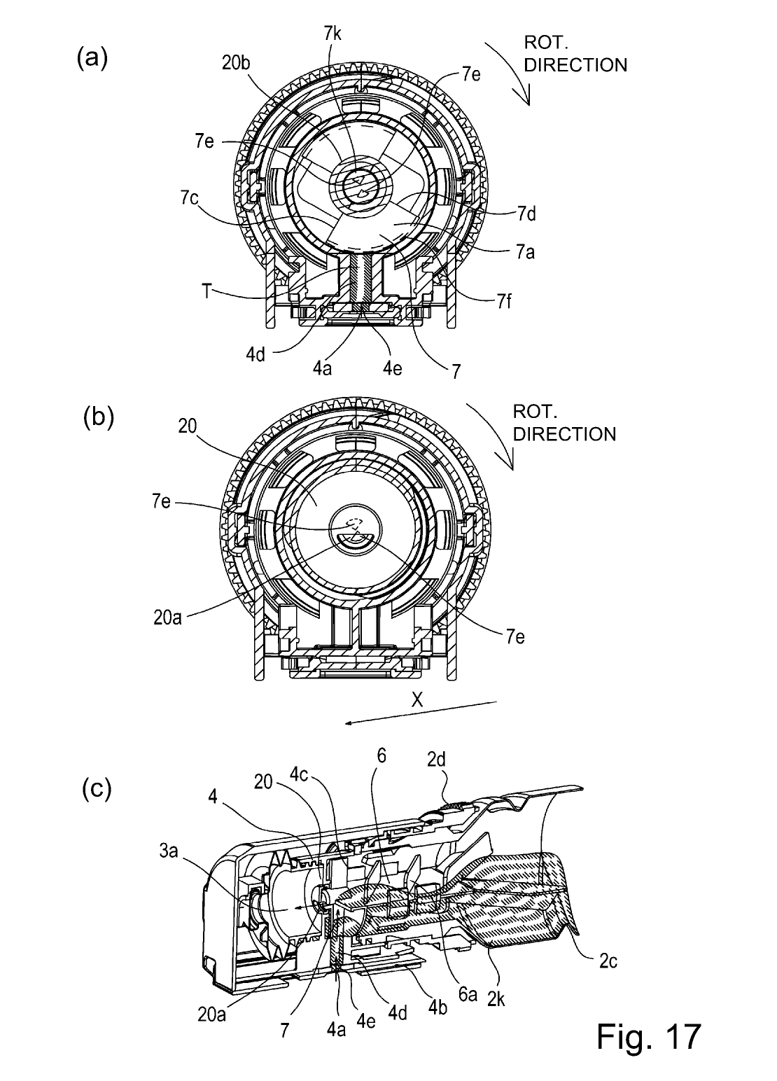

As shown in part (b) of FIG. 15, the opening 7e is sealed by the partition 20 and is not in fluid communication with the fluid communication path 20a. That is, no fluid communication state is established between the storage portion 4d and the pump portion 3a. As a result, the regulating portion 7 does not act on the storage portion 4d, so that the developer T fed by the feeding member 6 and the neighborhood of the upper portion of the storage portion 4d flows into the storage portion 4d and is stored there (non-regulation state of the entering of the developer). When the feeding member 6 rotates from this position, the states become as shown in FIG. 16.

In the state shown in FIG. 16, the pump portion 3a is in the suction stroke which is from the most contracted state to the most expanded state. At this time, the regulating portion 7 rotates with the rotation of the feeding member 6, so that the storage portion opening 7f covers the upper portion of the storage portion 4d from the non-covering state. As shown in part (b) of FIG. 16, the opening 7e in fluid communication with the storage portion opening 7f in the storage portion (4d) covering side becomes in fluid communication with a part of the fluid communication path 20a. Thus, the pump portion 3a becomes in fluid communication with the storage portion 4d through the fluid communication path 20a, the opening 7e and the storage portion opening 7f. The other opening 7e is sealed by the partition 20 as the suppressing portion. In this embodiment, the partition 20 is rotatable integrally with the regulating portion. Substantially in the neighborhood of the central portion of the rotational axis of the partition 20, there is provided an opening which is in fluid communication with the opening 7e.

When the pump portion 3 expands in the suction stroke, the pressure in the pump portion 3a becomes negative, so that the air outside the supply container 1 flows into the supply container 1 through the second discharge opening 4a by the pressure difference between the inner and outer of the supply container 1, as shown in part (c) of FIG. 16. More particularly, the air taken in the second discharge opening 4a passes through the storage portion 4d and directs into the pump portion 3a through the storage portion opening 7f and the opening 7e from the fluid communication path 20a. At this time, as shown in part (c) of FIG. 16, the pump portion 3a is isolated from the discharging portion 4c by the partition 20, and therefore, the air is hardly distributed into the discharging portion 4c. That is, the partition 20 is provided between the pump portion and the discharging portion 4c in the rotational axis direction (rotational axis direction of the supply container).

As a result, the developer T stored in the storage portion 4d in the above-described stroke contains the air taken in through the second discharge opening 4a, and therefore, the bulk density becomes low, that is, fluidized. In addition, because of the air taken in the discharging portion 4c does not scatter, the momentum of the air passing through the storage portion 4d is large, so that the developer having been packed in the storage portion 4d by the transportation can be fluidized.

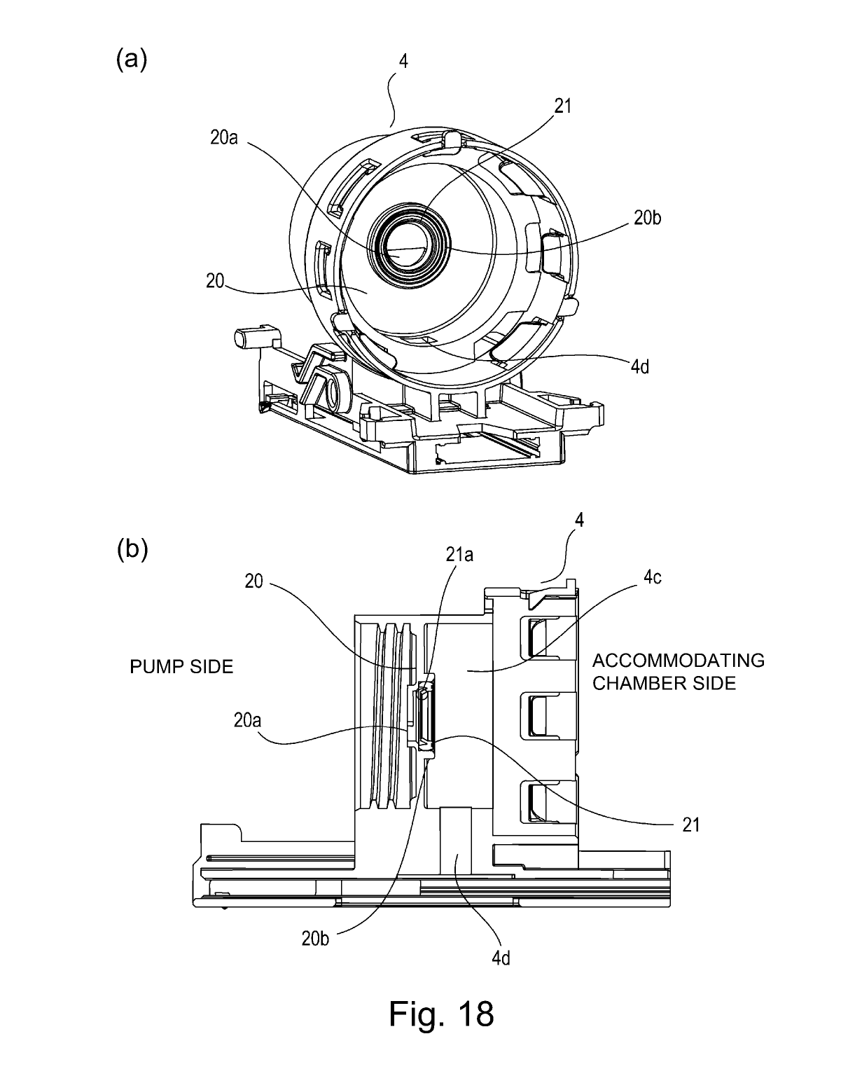

In the upper portion of the storage portion 4d, the radial wall 7c in the downstream of the regulating portion 7 with respect to the rotational direction of the rotational moving direction displaces the developer T in the upper portion of the storage portion 4d by the storage portion opening 7f of the regulating portion 7 covering the upper portion of the storage portion 4d with the rotation of the regulating portion 7. The storage portion opening 7f of the regulating portion 7 covers a part of the upper portion of the storage portion 4d. As a result, the flowing of the developer T in the neighborhood of the storage portion 4d into the storage portion 4d is limited by the thrust walls 7a and 7b and radial walls 7c and 7d of the regulating portion 7 (developer entering limited state). By the feeding member 6 rotating further, the state becomes as shown in FIG. 17.

In FIG. 17, the pump portion 3a is in the discharging stroke in which the pump portion 3a changes from the most expanded state to the most contracted state. At this time, the regulating portion 7 rotates with the rotation of the feeding member 6 so that at least a part of the storage portion opening 7f covers of the upper portion of the storage portion 4d. As shown in part (b) of FIG. 17, the opening 7e becomes in fluid communication with the fluid communication path 20a. That is, similarly to the state shown in part (b) of FIG. 16, the inside of the pump portion 3a is in fluid communication with the storage portion 4d through the fluid communication path 20a, the opening 7e and the storage portion opening 7f.

The other opening 7e is sealed by the partition 20. Thus, the air flow is directed positively toward the storage portion 4d from the inside of the pump portion 3a, and hardly scatters toward the discharging portion 4c. In this state, by the pump portion 3a contracting in the discharging stroke, the internal pressure of the supply container 1, more particularly, the internal pressure in the neighborhood of the storage portion 4d becomes higher than the ambient pressure. As a result, the developer T fluidized in the storage portion 4d by the suction stroke is discharged into the supplying device 201 together with the air through the second discharge opening 4a.

Also in the discharging stroke, too, the state in the upper portion of the storage portion 4d is such that with the rotation of the regulating portion 7, the radial wall 7c in the downstream side of the regulating portion 7 with respect to the rotational direction places the toner in the upper portion of the storage portion 4d, continuing from the state of the suction stroke. In addition, a part of the storage portion opening 7f of the regulating portion 7 always covers of the upper portion of the storage portion 4d. As a result, in the discharging stroke, the flowing of the developer T in the neighborhood of the upper portion of the storage portion 4d into the storage portion 4d is always limited by the thrust walls 7a, 7b and the radial walls 7c, 7d of the regulating portion 7 (developer entering limited state).

Here, the detailed description will be made as to the air flow in the supply container 1, which is applied to the developer Tin the storage portion 4d during the discharging stroke. The air in the discharging stroke to the storage portion 4d flows through following two ways. In one of them, the air flows from the pump portion 3a to the developer T in the storage portion 4d through the fluid communication path 20a of the partition 20, the opening 7e of the regulating portion 7, the fluid communication path 7g in the regulating portion 7 and the storage portion opening 7f in the order named.

In the other way, the air flows from the pump portion 3a to the developer T in the discharging portion 4c or cylindrical portion 4k through the fluid communication path 20a of the partition 20, the opening 7e of the regulating portion 7, the fluid communication path 7g in the regulating portion 7, the storage portion opening 7f, and a gap formed between the upper portion of the storage portion 4d and the lower end of the regulating portion 7.

However, the air flow to the storage portion 4d in the discharging stroke is mainly through the former way, for the following reason.

The developer T in the neighborhood of the outer periphery of the storage portion opening 7f of the regulating portion 7 covering the upper portion of the storage portion 4d in the discharging stroke is prevented from entering the storage portion 4d by the thrust walls 7a, 7b and the radial walls 7c, 7d of the regulating portion 7. Therefore, in the discharging portion 4c in the neighborhood of the outer periphery of the storage portion opening 7f of the regulating portion 7, the developer T stagnates. Therefore, the air flow toward the discharging portion 4c is resisted by the developer T. In the state, the developer T in the storage portion 4d resistance the airflow, similarly, but in the suction stroke in this embodiment, the air taken in through the second discharge opening 4a does not scatter toward the discharging portion 4c because of the provision of the partition 20, and the developer in the storage portion 4d is positively fluitized.

Therefore, the resistance of the developer T in the storage portion 4d against the air flow is much smaller than the resistance of the developer T stagnating in the discharging portion 4c against the air flow. As a result, the main air flow in the discharging stroke is directed to the storage portion 4d, because the resistance by the developer T against the air flow is smaller. In the discharging stroke, the developer T in the storage portion 4d which is in fluid communication with the fluid communication path 7g is discharged into the supplying device 201 together with the following air having passed through the fluid communication path 7g in the regulating portion 7. In addition, as described hereinbefore, in the discharging stroke, the storage portion 4d is always in the developer entering limited state by which the entering of the developer T is always limited by the regulating portion 7, and therefore, a substantially constant amount of the developer is stored in the storage portion 4d.

In addition, the internal pressure in the supply container 1 in the discharging stroke becomes equivalent to the ambient pressure at the time when the developer T in the storage portion 4d is discharged to give that with the air, by which the inside and the outside of the supply container 1 become in fluid communication with each other. Therefore, after the developer T in the storage portion 4d is discharged, no air flow is produced by the pressure difference for discharging the developer T from the supply container, and therefore, the developer T is hardly discharged. For this reason, in the discharging stroke, only the constant amount of the developer T stored in the storage portion 4d is discharged, and therefore, the developer can be discharged into the supplying device 201 with very high supply accuracy.

In addition, even if the developer T is packed in the fluid communication path 7g, for example, by the vibration during transportation, the packed state can be assuredly removed because the air flow produced by the contraction of the pump portion 3a is directed mainly through the fluid communication path 7g to the storage portion 4d according to this embodiment. Therefore, the air can be applied mainly on the storage portion 4d in that stabilized manner, and therefore, the developer T can be stably discharged into the supplying device 201. In addition, with the supply container 1 of the embodiment, the suction and discharging air mainly passes through the fluid communication path 7g, the amount of the developer T deposited in the fluid communication path 7g can be reduced, and therefore, the suction and discharging air can be applied to the storage portion 4d stably.

### Modified Example

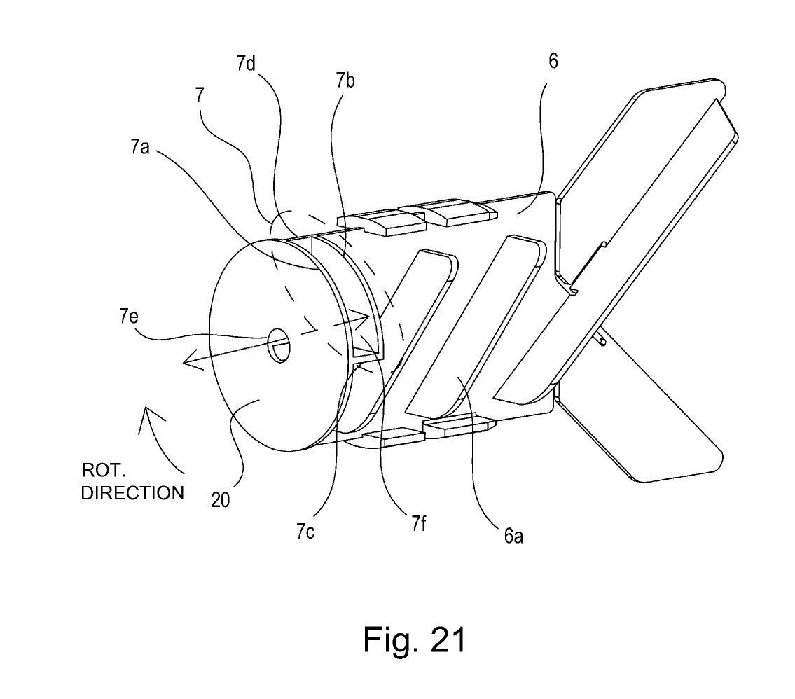

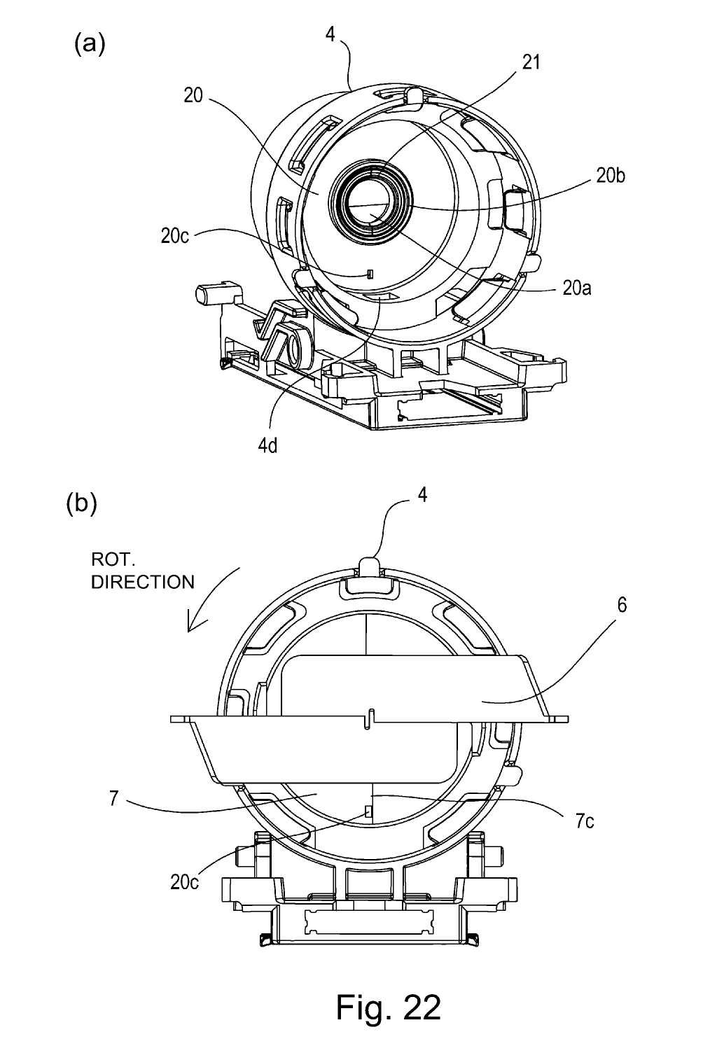

FIG. 21 is an enlargement perspective view of the feeding member 6 of the supply container 1 according to a modified example of Embodiment 2. In the description of this embodiment, the same reference numerals as in Embodiment 2 are assigned to the elements having the same structures and functions in this embodiment, and the detailed description thereof is omitted for simplicity. As shown in FIG. 21, with the supply container 1 of the modified example, the partition 20 is formed on the feeding member 6, and the partition 20 as the suppressing portion is integral with the opening 7e of the regulating portion 7. The partition 20 is mounted on the regulating portion 7. Therefore, the inside of the pump portion 3a is in fluid communication with the storage portion 4d through the opening 7e, the fluid communication path 7g and the storage portion opening 7f. The outer diameter of the partition 20 (the outer diameter of the regulating portion 7) and the inner diameter of the discharging portion 4c are so selected that a gap is provided therebetween to accomplish smooth rotation of the feeding member 6 relative to the flange portion 4. However, the gap is so small that the air flow is hardly influenced in the expanding-and-contracting operation of the pump portion 3a.

For this reason, the functions of the partition 20 and the air flow in the suction stroke and the discharging stroke are similar to the case of Embodiment 2. In this example, the partition 20 and the thrust wall 7a of the regulating portion 7 are on the same plane, and therefore, the dimension of the supply container 1 can be reduced as compared with Embodiment 2. More particularly, with the supply container 1 of Embodiment 2, the partition 20 and the thrust wall 7a are provided by separate members, respectively, and a relative rotation occurs between the partition 20 (provided on the flange portion 4) and the thrust wall 7a (provided on the feeding member 6). Therefore, a clearance is required in the thrust direction, for smooth relative rotation therebetween.

In other words, as compared with the structure of this example, the structure of Embodiment 2 requires additional length corresponding to the clearance (approx. 1 mm in that embodiment) plus the thickness of the partition (approx. 1.5 mm in that embodiment) in the thrust direction. Therefore, when the reduction of the length of the supply container 1 in the thrust direction is desired, the modified example is advantageous.

### Embodiment 3

Part (a) of FIG. 22 is a perspective view of the flange portion 4 in the supply container 1 according to Embodiment 3. Part (b) of FIG. 22 is a sectional view illustrating a positional relation between the feeding member 6 and the flange portion 4 in the discharging stroke in this embodiment. In the description of this embodiment, the same reference numerals as in Embodiment 1 or 2 are assigned to the elements having the same structures in this embodiment, and the detailed description thereof is omitted for simplicity. The flange portion 4 of this embodiment is different from that of Embodiment 2 in a part of partition 20.

(Flange Portion)

As shown in part (a) of FIG. 22, the flange portion 4 is provided with the partition 20 as the suppressing portion. The partition 20 is provided with a fluid communication path 20c as a passable opening. The fluid communication path 20c is provided below the fluid communication path 20a and provides a fluid communication path between the pump portion 3a and the cylindrical portion 2k to pass the developer T therethrough. The fluid communication path 20c is disposed above and adjacent to the upper portion of the storage portion 4d.

As shown in parts (a) and (b) of FIG. 22, as seen in the rotational axis direction of the supply container 1, the dimension measured in the widthwise direction of the fluid communication path 20c is selected such that the width is within the imaginary extension of the storage portion 4d in the vertical direction. In the change of the pump portion 3a to the discharging stroke, the regulating portion 7 is in the position opposing fluid communication path 20c as seen in the rotational axis direction of the supply container 1, so that the regulating portion 7 can limit the amount of the developer T going out of the fluid communication path 20c. The size of the fluid communication path 20c is so selected that the area is smaller than the cross-sectional area of the fluid communication path 20a, in order to positively apply the air flow produced by the pump portion 3a onto the fluid communication path 20a.

(Suction Stroke)

The suction stroke of the supply container 1 will be described. By the expansion of the pump portion 3a, the air is taken into the supply container 1, so that the developer T is stored in the neighborhood of the fluid communication path 20c. The air taken in through the second discharge opening 4a is supplied into the pump portion 3a through the storage portion 4d, the opening 7e and the fluid communication path 20a. The developer T in the storage portion 4d is fluitized by the air taken in. In this embodiment and also in Embodiment 2, a small amount of developer T is taken in pump portion 3a together with the air through the fluid communication path 20a. Therefore, in the period from the initial state in which a large amount of the developer is contained in the developer supply container to the near end of the service life of the developer container, a quite large amount of the developer T is accumulated in the pump portion 3a.

(Discharging Stroke)

The discharging stroke of the supply container 1 in this embodiment will be described. After the suction stroke in this embodiment, the pump portion 3a is contracted such that the air in the supply container 1 is discharged to the outside of the supply container 1 together with the developer T, similarly to the case of part (c) of FIG. 17. In the initial state of the developer container 1, a sufficient amount of the developer T is contained in the supply container 1, and the developer T stagnates adjacent to the fluid communication path 20c, and the stagnated developer functions as a resistance against the flow of the air, and therefore the air hardly flows into the fluid communication path 20c. Therefore, similarly to the case of supply container 1 of Embodiment 2, the air is discharged together with the developer T through the fluid communication path 20a, the opening 7e, storage portion 4d and the second discharge opening 4a.

As described hereinbefore, in this embodiment, in the initial state in which a large amount of the developer T is contained in the supply container 1, the air flow to the storage portion 4d in the suction discharging stroke is the same as in the supply container 1 of Embodiment 2.

However, the air flow becomes different from that in Embodiment 2, in the near end of the service life of the supply container 1 in which the amount of the developer T in the supply container 1 is small. More particularly, in the near end state, the flow of the air taken in through the second discharge opening 4a in the suction stroke includes the flow into the pump portion 3a through the storage portion 4d, the opening 7e and the fluid communication path 20a, similarly to the initial state. In addition, there is a flow of the air into the pump portion 3a through the storage portion 4d from the fluid communication path 20c. These two ways of flow are produced.

This is because the reduction of the contained developer T decreases the amount of the developer T stagnating in the neighborhood of the storage portion 4d. In such a case, the flow of the suction air is distributed widely, and therefore, the momentum of the air flow through the storage portion 4d is slightly smaller than that in the initial state. However, in the near in the state, the packed state of the developer T in the storing portion 4d has already been removed as compared with the initial state, and therefore, despite the slight reduction of the momentum of the air flow, the developer T can be fluitized.

Subsequently, in the discharging stroke, similarly to the suction stroke, the amount of the developer T stagnating in the neighborhood of the storage portion 4d is small. Therefore, the flow of the discharging air produced by the pump portion 3a includes the flow to the storage portion 4d from the opening 7e through the fluid communication path 20a and the flow toward the storage portion 4d from the pump portion 3a through the fluid communication path 20c. By the latter air flow, the developer T taken into and accumulate and in the pump portion 3a by the suction stroke is fed through the fluid communication path 20c into the storage portion 4d, and then is discharged through the second discharge opening 4a.

That is, the amount of the developer T accumulated in the pump portion 3a decreases. Therefore, when the supply container 1 is exchanged, the amount of the developer T the remaining in the supply container 1 is smaller than that in the case of the supply container 1 of Embodiment 2. The supply container 1 of this embodiment is better than that of Embodiment 2 in that the amount of the developer T remaining in the pump portion 3a in the near end of the service life of the supply container 1 can be reduced. By a reduction, the developer supply container of this embodiment is better from the standpoint of the running cost and environmental health, because the amount of the remaining developer T is small, and therefore, the user can use the developer T to the extent without remaining amount.

### Comparison Example

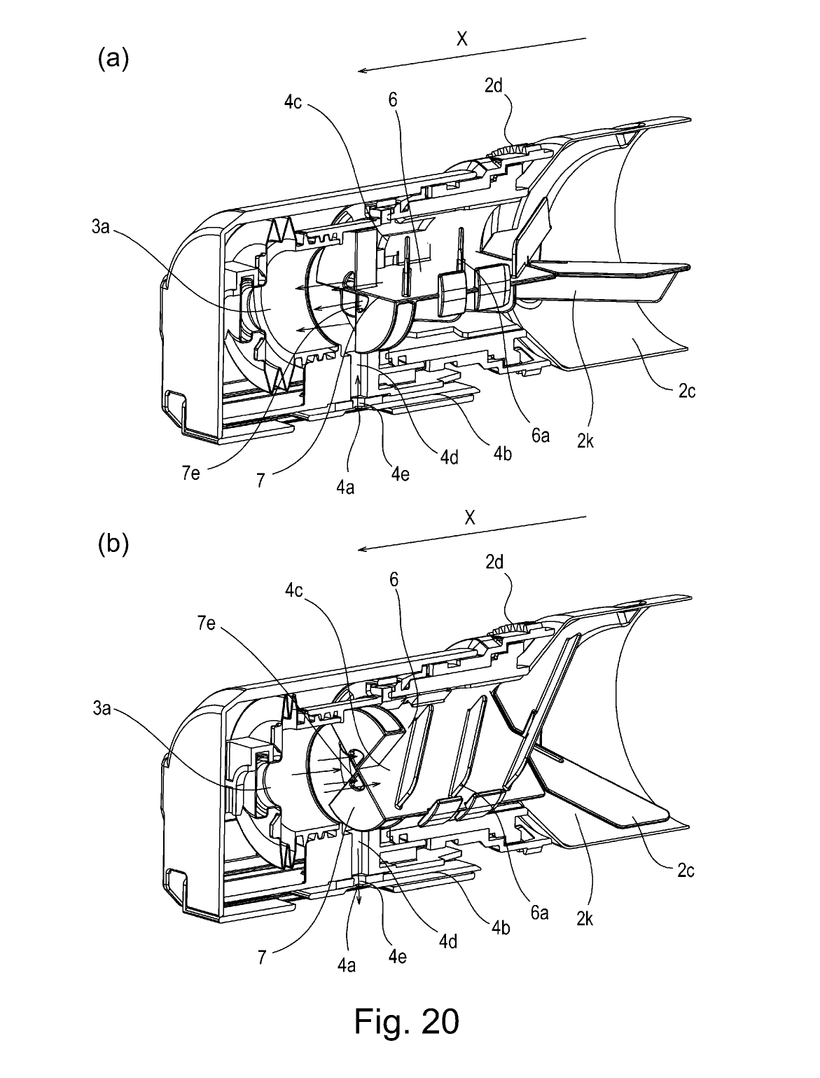

FIG. 20 is a partly enlarged perspective view of a supply container 1 according to a comparison example (conventional example). The supply container 1 shown in FIG. 20 is not provided with the partition 20 on the flange portion 4, the fluid communication path 20a in the partition 20, the annular rib 20b, or the cylindrical shaft portion 7k of the regulating portion 7 of the feeding member 6. The other structures are the same as those of this Embodiment 2.

As shown in FIG. 20, in the conventional example, the partition 20 as the suppressing portion is not provided between the pump portion 3a and the discharging portion 4c, and the inside of the pump portion 3a and the inside of the discharging portion 4c are not isolated. Therefore, as shown in part (a) of FIG. 20, in the suction stroke, the total volume of the pump portion 3a, the discharging portion 4c and the cylindrical portion 2k increases by the increase of the inside volume of the pump portion 3a, by the expansion of the pump portion 3a, and the pressure in the supply container 1 decreases to less than the ambient pressure (negative pressure). The pressure difference of the neighborhood of the storage portion 4d and the ambient pressure is much smaller than that in the case of supply container 1 of Embodiment 2.

Therefore, the momentum of the air taken into the supply container 1 through the second discharge opening 4a is smaller. In addition, the air is taken in also through the second discharge opening 4a and the discharging portion 4c as well as the opening 7e. For this reason, the fluidizing function of the flow of the air into the storage portion 4d to the packed developer T is poorer. In order to provide the momentum of the air to the storage portion 4d equivalent to that of the embodiment, a larger inside volume of the pump portion 3a or larger expansion amount of the pump portion 3a of the supply container 1 of this embodiment would be required.

The expanding-and-contracting operation of the pump portion 3a is provided by converting the rotation of the supply container 1 to the reciprocation of the pump portion 3a by the drive converting mechanism (cam groove), and therefore, the increase of the inside volume and/or the expansion amount of the pump portion 3a is influential to the rotational force required by the supply container 1. More particularly, the increase of the rotational load required by the supply container 1 necessitates the increase of the driving power of the image forming apparatus side.

In the supply container 1 of this embodiment, by the function of the partition 20 and the fluid communication path 20a described in the foregoing, the air can be applied efficiently to the storage portion 4d. Therefore, the packed developer T in the developer container can be fluitized without increasing the expansion amount or the inside volume of the pump portion 3a.

In the supply container 1 of the comparison example, in the discharging stroke, the flow of the air produced in the contraction stroke of the pump portion 3a is directed to the discharging portion 4c as well as to the opening 7e, because no partition 20 is provided, and the pump portion 3a and the discharging portion 4c are in fluid communication with each other without isolation therebetween, as shown in part (b) of FIG. 20. For this reason, the flow of the air applied to the storage portion 4d through the opening 7e is smaller than that in the case of the supply container 1 of this embodiment, and therefore, the amount of the air to be used for the discharge of the developer T stored in the storage portion 4d is smaller.

As will be understood from the foregoing, according to this embodiment which employs the partition 20 and the opening 7e provided in the regulating portion 7 to the right of fluid communication between the inside of the pump portion 3a and the storage portion 4d, the constant amount of the developer T Stored in the storage portion 4d can be always discharged into the supplying device 201 in the discharging stroke. That is, the developer T can be discharged with highly stabilized supply accuracy.

In this embodiment, the feeding member 6 is provided with two such regulating portions 7, but this is not inevitable to the present invention. The two regulating portions 7 are provided corresponding to the two discharging strokes in the 360° rotation of the cylindrical portion 2k. If, for example, three discharging strokes are provided in the 360° rotation of the cylindrical portion 2k, three regulating portions 7 may be provided.

In addition, with the structure of this embodiment, the regulating portion 7 is provided integrally with the feeding member 6 which is the movable portion, as described above, and therefore, the regulating portion 7 integrally rotates together with the cylindrical portion 2k. In this structure, the driving force for rotating the cylindrical portion 2k and the driving force for reciprocating the pump portion 3a are received by a single drive receiving portion (gear portion 2d).

In addition, the driving force for rotating the regulating portion 7 is also received by a single drive receiving portion (gear portion 2d) together with the driving force for rotating the cylindrical portion 2k. That is, the structure of this embodiment requires to receive three driving forces for the rotation of the cylindrical portion 2k, for the reciprocation of the pump portion 3a and for the rotation of the regulating portion 7, and these three driving forces are received by one drive receiving portion (gear portion 2d).

Therefore, the structure of this embodiment can significantly simplify the structure of the drive inputting mechanism for the supply container 1, as compared with the case in which three drive receiving portions are provided in the supply container 1. In addition, because the driving forces are received by a single driving mechanism (driving gear 300) of the developer supplying apparatus 201, the driving mechanism for the developer supplying apparatus 201 is also significantly simplified.

### [Verification]

The discharging performance of the developer supply containers Embodiment 1, Embodiment 2 and Embodiment 3 were verified as compared with the conventional developer supply container. The verification method and verification items are as follows.

First, predetermined vibration close to that during the transportation of the supply container 1 is imparted by a vibration impartment machine to pack the developer T in the supply container 1. The discharging operation is started at this state, and the number of pumping operations until the discharge of the developer T actually starts from the discharging operation start. In addition, the time periods from the discharging start to the stabilization of the discharge amount (nearly equal to stabilization time) are compared. Finally, the amounts of the developer T remaining in the supply container 1 in the near end of the discharging are compared. The results are shown in Table 2.

As to those factors such as the number of pumping operation, the stabilization time or the remaining developer T amount, there is no constant quantitative references for OK/NG determination, which may be different if the specification of the main assembly of the image forming apparatus to which the supply container 1 is mounted, or the like is different. Therefore, a relative comparison is made. Therefore, the level A, the level B and the level C are given in the order of the better relative performance. The same levels mean equivalent performance. As a result of the comparison verification, the supply container 1 of this embodiment is better in the performance.

TABLE 2

| | Discharge | | |
|---|---|---|---|
| | start | Time required | Remaining |
| | pumping | for | developer amount |
| | number | stabilization | T |
| Conventional example | Level C | Level C | Level A |
| Embodiment 1 | Level A | Level B | Level A |
| Embodiment 2 | Level A | Level A | Level B |
| Embodiment 3 | Level A | Level A | Level A |

As described in the foregoing, in this embodiment, by the provision of the partition 20 between the pump portion 3a and the discharging portion 4c, the flow of the air produced by the expanding-and-contracting operation of the pump portion 3a can be efficiently applied to the storage portion 4d. Therefore, as compared with the conventional supply container 1, the supply container 1 of this embodiment exhibits good discharging properties (number of pumping operations to the start of the toner discharge, the stabilization time).

According to the embodiments of the present invention, the air can be concentratedly applied to the discharging portion at the time of toner discharging, thus accomplishing stabilized developer discharge.

### INDUSTRIAL APPLICABILITY

According to the present invention, the air can be concentrated to the discharging portion during the toner discharging, and therefore, the developer can be stably discharged.

1. A developer supply container detachably mountable to a developer supplying apparatus, said developer supply container comprising:
a developer accommodating chamber capable of accommodating a developer;
a discharge opening, provided on said developer accommodating chamber, for permitting discharge of the developer therein;
a storage portion provided in said developer accommodating chamber and capable of storing a predetermined amount of the developer through said discharge opening;
a pump portion having a changeable inside volume with reciprocation and actable at least on said storage portion;
an air hole portion providing fluid communication between said pump portion and said storage portion; and
a suppressing portion capable of suppressing air directing toward said developer accommodating chamber from said pump portion while permitting supply of air from said pump portion to said air hole portion, at least in a discharging operation.

2. A developer supply container according to claim 1, further comprising a regulating portion movable between a regulating position for regulating flow of the developer to said storage portion and a non-regulating position not regulating the flow of the developer to said storage portion, wherein said regulating portion is moved to the regulating position to cover at least a part of said storage portion so as to guide the flow of the air produced by said pump portion when said pump portion carries out the discharging operation, and wherein said air hole portion is formed in a part of said regulating portion.

3. A developer supply container according to claim 2, wherein said regulating portion is rotatable, and said air hole portion is disposed adjacent to a rotation axis.

4. A developer supply container according to claim 3, wherein said suppressing portion is disposed between said regulating portion and said pump portion in a direction of the rotation axis of said regulating portion.

5. A developer supply container according to claim 2, wherein said suppressing portion is provided in said regulating portion and is rotatable integrally with said regulating portion.

6. A developer supply container according to claim 4, wherein said suppressing portion has a circular shape, and said air hole portion is disposed adjacent to a center of the circular shape.

7. A developer supply container according to any one of claims 1-6, wherein said suppressing portion is provided at a position vertically below said air hole portion with an opening capable of providing fluid communication between said pump portion and said developer accommodating chamber and capable of passing the developer therethrough.

8. A developer supplying apparatus comprising a mounting portion for mounting said developer supply container according to any one of claims 1-7.
